(19) United States
(12) Patent Application Publication
(10) Pub. No.: US 2023/0166762 A1
(43) Pub. Date: Jun. 1, 2023

(54) CONTROL SYSTEM OF UNMANNED VEHICLE, UNMANNED VEHICLE, AND METHOD OF CONTROLLING UNMANNED VEHICLE

(71) Applicant: Komatsu Ltd., Tokyo (JP)

(72) Inventors: Yosuke Kadono, Tokyo (JP); Misato Maeda, Tokyo (JP)

(73) Assignee: Komatsu Ltd., Tokyo (JP)

(21) Appl. No.: 18/011,952

(22) PCT Filed: May 25, 2021
(86) PCT No.: PCT/JP2021/019797

§ 371 Date: Dec. 21, 2022

(30) Foreign Application Priority Data
Jul. 29, 2020 (JP) 2020-128166

(51) Int. Cl. B60W 60/00; B60W 50/10

(52) U.S. Cl. CPC B60W 60/001; B60W 50/10; B60W 2420/42; B60W 2510/18

(57) ABSTRACT

A control system of an unmanned vehicle includes a traveling control unit that outputs a first command for starting the unmanned vehicle. When the unmanned vehicle is determined not to be started by a first command, a traveling control unit outputs a second command that causes the unmanned vehicle to generate assist driving force.

### FIELD

The present disclosure relates to a control system of an unmanned vehicle, the unmanned vehicle, and a method of controlling the unmanned vehicle.

### BACKGROUND

In a wide-area work site such as a mine, unmanned vehicles operate. As disclosed in Patent Literature 1, an unmanned vehicle may operate in an oil sand mine. Oil sands refers to sandstones containing a high-viscosity mineral oil component.

### CITATION LIST

### Patent Literature

Patent Literature 1: WO 2016/080555

### SUMMARY

### Technical Problem

Oil sands are soft like a sponge. At least a part of tires of an unmanned vehicle may be buried in the oil sands due to the weight of the unmanned vehicle. When at least a part of tires of the unmanned vehicle is buried in the oil sands at the time when the unmanned vehicle is stopped, the unmanned vehicle may have difficulty in starting. If the unmanned vehicle cannot start or it takes a long time for the tires to escape from the oil sands, the productivity of a work site may decrease.

An object of the present disclosure is to inhibit a decrease in productivity of a work site where an unmanned vehicle operates.

### Solution to Problem

According to an aspect of the present invention, a control system of an unmanned vehicle, comprises a traveling control unit that outputs a first command for starting the unmanned vehicle, wherein, when the unmanned vehicle is determined not to be started by the first command, the traveling control unit outputs a second command for causing the unmanned vehicle to generate assist driving force.

### Advantageous Effects of Invention

According to the present disclosure, a decrease in productivity of a work site where an unmanned vehicle operates is inhibited.

### BRIEF DESCRIPTION OF DRAWINGS

FIG. 1 is a schematic diagram illustrating a management system of an unmanned vehicle according to a first embodiment.

FIG. 2 is a schematic diagram illustrating a work site according to the first embodiment.

FIG. 3 is a schematic diagram for illustrating course data according to the first embodiment.

FIG. 4 is a schematic diagram for illustrating the operation of the unmanned vehicle in a loading place according to the first embodiment.

FIG. 5 is a functional block diagram illustrating a control system of the unmanned vehicle according to the first embodiment.

FIG. 6 illustrates one example of the unmanned vehicle in a normal state according to the first embodiment.

FIG. 7 illustrates a first starting condition according to the first embodiment.

FIG. 8 illustrates one example of the unmanned vehicle in an abnormal state according to the first embodiment.

FIG. 9 illustrates a second starting condition according to the first embodiment.

FIG. 10 is a flowchart illustrating a method of controlling the unmanned vehicle according to the first embodiment.

FIG. 11 illustrates one example of the unmanned vehicle in the normal state according to a second embodiment.

FIG. 12 illustrates the first starting condition according to the second embodiment.

FIG. 13 illustrates one example of the unmanned vehicle in the abnormal state according to the second embodiment.

FIG. 14 illustrates the second starting condition according to the second embodiment.

FIG. 15 is a functional block diagram illustrating the control system of the unmanned vehicle according to a third embodiment.

FIG. 16 illustrates image data obtained by an imaging device according to the third embodiment.

FIG. 17 illustrates the image data obtained by the imaging device according to the third embodiment.

FIG. 18 is a flowchart illustrating a method of controlling the unmanned vehicle according to the third embodiment.

### DESCRIPTION OF EMBODIMENTS

Embodiments of the present disclosure will be described below with reference to the drawings, but the present disclosure is not limited to the embodiments. Components in the embodiments described below can be appropriately combined. Furthermore, some components are not used in some cases.

In the embodiments, a local coordinate system is set for an unmanned vehicle, and relations between positions of components will be described with reference to the local coordinate system. A first axis extending in a right-and-left direction (vehicle width direction) of the unmanned vehicle is defined as a pitch axis PA. A second axis extending in a front-and-rear direction of the unmanned vehicle is defined as a roll axis RA. A third axis extending in an up-and-down direction of the unmanned vehicle is defined as a yaw axis YA. The pitch axis PA and the roll axis RA are orthogonal to each other. The roll axis RA and the yaw axis YA are orthogonal to each other. The yaw axis YA and the pitch axis PA are orthogonal to each other.

### First Embodiment

### Management System

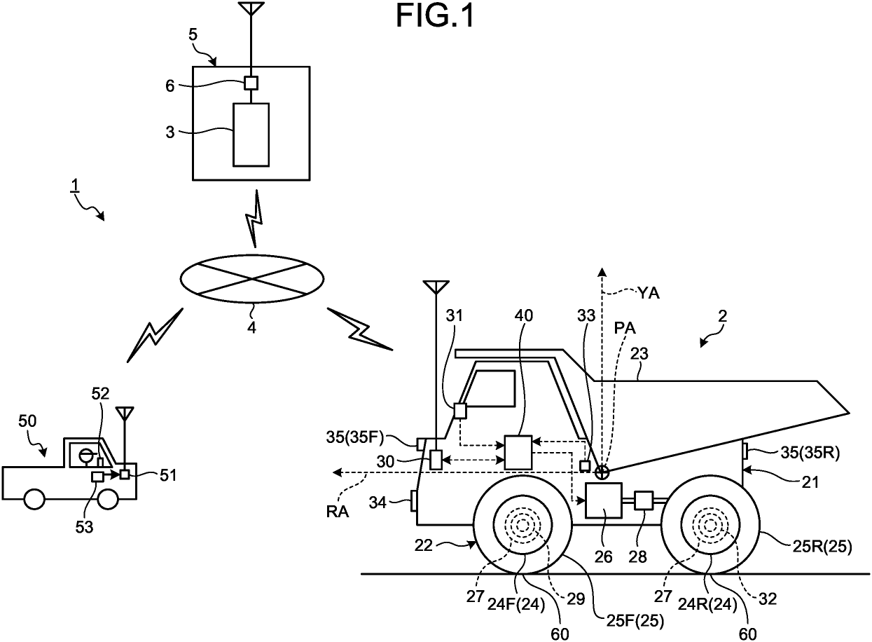

A first embodiment will be described. FIG. 1 is a schematic diagram illustrating a management system 1 of an unmanned vehicle 2 according to the embodiment. The unmanned vehicle 2 refers to a work vehicle that operates in an unmanned manner without depending on a driving operation of a driver. The unmanned vehicle 2 operates at a work site. Examples of the work site include a mine and a quarry. The unmanned vehicle 2 is an unmanned dump truck that travels in a work site in an unmanned manner and transports a cargo. The mine refers to a place or business facilities for mining minerals. The quarry refers to a place or business facilities for mining stones. Examples of the cargo transported by the unmanned vehicle 2 include ore and soil excavated in the mine or the quarry.

The management system 1 includes a management device 3 and a communication system 4. The management device 3 includes a computer system. The management device 3 is installed in a control facility 5 of the work site. An administrator is in the control facility 5. The management device 3 and the unmanned vehicle 2 wirelessly communicate with each other via the communication system 4. A wireless communication device 6 is connected to the management device 3. The communication system 4 includes the wireless communication device 6. The management device 3 generates course data indicating a traveling condition of the unmanned vehicle 2. The unmanned vehicle 2 operates in the work site based on the course data transmitted from the management device 3.

### Unmanned Vehicle

The unmanned vehicle 2 includes a vehicle body 21, a traveling device 22, a dump body 23, a wireless communication device 30, a position sensor 31, a speed sensor 32, an inclination sensor 33, a non-contact sensor 34, imaging devices 35, and a control device 40.

The vehicle body 21 includes a vehicle body frame. The traveling device 22 supports the vehicle body 21. The vehicle body 21 supports the dump body 23.

The traveling device 22 causes the unmanned vehicle 2 to travel. The traveling device 22 moves the unmanned vehicle 2 forward or backward. At least a part of the traveling device 22 is disposed below the vehicle body 21. The traveling device 22 includes wheels 24, tires 25, a driving device 26, brake devices 27, a retarder 28, and a steering device 29.

The tires 25 are mounted on the wheels 24. The wheels 24 include front wheels 24F and rear wheels 24R. The tires 25 include front tires 25F and rear tires 25R. The front tires 25F are mounted on the front wheels 24F. The rear tires 25R are mounted on the rear wheels 24R.

The driving device 26 generates driving force for starting or accelerating the unmanned vehicle 2. Examples of the driving device 26 include an internal combustion engine and an electric motor. Examples of the internal combustion engine include a diesel engine. The driving force generated by the driving device 26 is transmitted to the wheels 24. In the embodiment, the wheels 24 to which the driving force is transmitted are the rear wheels 24R. Note that the wheels 24 to which the driving force is transmitted may be the front wheels 24F or both the front wheels 24F and the rear wheels 24R. Rotation of the wheels 24 causes the unmanned vehicle 2 to be self-propelled.

The brake devices 27 generate braking force for stopping or decelerating the unmanned vehicle 2. Examples of the brake devices 27 include a disc brake and a drum brake.

The retarder 28 is an auxiliary brake device that generates braking force for stopping or decelerating the unmanned vehicle 2. Examples of the retarder 28 include a fluid retarder and an electric retarder.

The steering device 29 generates steering force for adjusting a traveling direction of the unmanned vehicle 2. The traveling direction of the unmanned vehicle 2 moving forward refers to an orientation of a front portion of the vehicle body 21. The traveling direction of the unmanned vehicle 2 moving backward refers to an orientation of a rear portion of the vehicle body 21. The steering device 29 includes a steering cylinder. The steering cylinder is a hydraulic cylinder. The wheels 24 are steered by the steering force generated by the steering cylinder. In the embodiment, the steered wheels 24 are the front wheels 24F. Note that the steered wheels 24 may be the rear wheels 24R or both the front wheels 24F and the rear wheels 24R. The traveling direction of the unmanned vehicle 2 is adjusted by steering the wheels 24.

The dump body 23 is a member on which a cargo is loaded. At least a part of the dump body 23 is disposed above the vehicle body 21. The dump body 23 is hoisted by operation of a hoist cylinder. The hoist cylinder is a hydraulic cylinder. The dump body 23 is adjusted to have a loading posture or a dumping posture by hoisting force generated by the hoist cylinder. The loading posture refers to a posture in which the dump body 23 is lowered. The dumping posture refers to a posture in which the dump body 23 is raised.

The wireless communication device 30 wirelessly communicates with the wireless communication device 6. The communication system 4 includes the wireless communication device 30.

The position sensor 31 detects a position of the unmanned vehicle 2. The position of the unmanned vehicle 2 is detected by using a global navigation satellite system (GNSS). The global navigation satellite system includes a global positioning system (GPS). The global navigation satellite system detects the position in a global coordinate system specified by coordinate data of latitude, longitude, and altitude. The global coordinate system refers to a coordinate system fixed to the earth. The position sensor 31 includes a GNSS receiver, and detects the position of the unmanned vehicle 2 in the global coordinate system.

The speed sensor 32 detects a traveling speed of the unmanned vehicle 2.

The inclination sensor 33 detects an inclination angle of the unmanned vehicle 2. The inclination angle of the unmanned vehicle 2 includes a pitch angle Pθ, a roll angle Rθ, and a yaw angle Yθ. The pitch angle Pθ is an inclination angle of the unmanned vehicle 2 around the pitch axis PA. The roll angle Rθ refers to an inclination angle of the unmanned vehicle 2 around the roll axis RA. The yaw angle Yθ refers to an inclination angle of the unmanned vehicle 2 around the yaw axis YA. Examples of the inclination sensor 33 include an inertial measurement unit (IMU) and a gyro sensor.

In a state where lower ends 60 of the tires 25 are in contact with the ground parallel to the horizontal plane, each of the pitch angle Pθ and the roll angle Rθ is 0[°]. In the state where the lower ends 60 of the tires 25 are in contact with the ground parallel to the horizontal plane, each of the pitch axis PA and the roll axis RA is parallel to the horizontal plane. The lower ends 60 of the tires 25 refer to parts of outer peripheral surfaces of the tires 25, the parts being disposed on the lowermost sides in the up-and-down direction parallel to the yaw axis YA.

The non-contact sensor 34 detects an object around the unmanned vehicle 2 in a non-contact manner. The non-contact sensor 34 is provided at a lower portion of a front portion of the vehicle body 21. The non-contact sensor 34 detects an object in front of the unmanned vehicle 2 in a non-contact manner. Examples of the non-contact sensor 34 include a laser sensor (light detection and ranging (LIDAR)) and a radio detection and ranging (RADAR) sensor. The non-contact sensor 34 functions as an obstacle sensor.

The imaging devices 35 image the surroundings of the unmanned vehicle 2. A plurality of imaging devices 35 is provided on the vehicle body 21. The imaging devices 35 include a front imaging device 35F and a rear imaging device 35R. The front imaging device 35F images the front of the unmanned vehicle 2. The rear imaging device 35R images the rear of the unmanned vehicle 2. Note that the imaging devices 35 may include a left imaging device and a right imaging device. The left imaging device images the left of the unmanned vehicle 2. The right imaging device images the right of the unmanned vehicle 2.

The control device 40 includes a computer system. The control device 40 is disposed in the vehicle body 21. The control device 40 can communicate with the management device 3. The control device 40 outputs a control command for controlling the traveling device 22. The control command output from the control device 40 includes a driving command for operating the driving device 26, a braking command for operating the brake devices 27, a braking command for operating the retarder 28, and a steering command for operating the steering device 29. The driving device 26 generates driving force for starting or accelerating the unmanned vehicle 2 based on a driving command output from the control device 40. The brake devices 27 generate braking force for stopping or decelerating the unmanned vehicle 2 based on a braking command output from the control device 40. The retarder 28 generates braking force for stopping or decelerating the unmanned vehicle 2 based on a braking command output from the control device 40. The steering device 29 generates steering force for causing the unmanned vehicle 2 to travel straight or turn based on a steering command output from the control device 40.

### Auxiliary Vehicle

In the work site, not only the unmanned vehicle 2 but an auxiliary vehicle 50 operate. An auxiliary vehicle 50 is a manned vehicle. The manned vehicle refers to a vehicle that operates based on a driving operation of a driver on board.

The auxiliary vehicle 50 includes a wireless communication device 51, an operation device 52, and a control device 53.

The wireless communication device 51 wirelessly communicates with the wireless communication device 6. The communication system 4 includes the wireless communication device 51.

The operation device 52 is disposed in a cab of the auxiliary vehicle 50. The operation device 52 is operated by the driver to generate an operation command. Examples of the operation device 52 include a touch panel, a computer keyboard, and an operation button.

The control device 53 includes a computer system. The control device 53 is disposed in the auxiliary vehicle 50. The control device 53 can communicate with the management device 3.

### Work Site

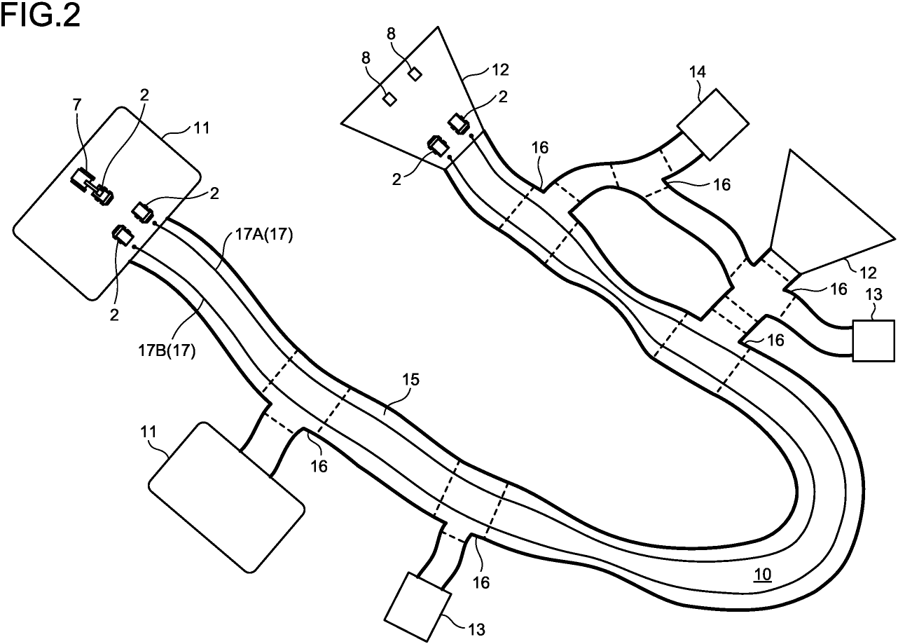

FIG. 2 is a schematic diagram illustrating the work site according to the embodiment. In the embodiment, the work site is a mine. Examples of the mine include a metal mine for mining metal, a non-metal mine for mining limestone, and a coal mine for mining coal. Examples of a cargo transported by the unmanned vehicle 2 include mined objects excavated in the mine.

A traveling area 10 is set in the work site. In the traveling area 10, the unmanned vehicle 2 is permitted to travel. The unmanned vehicle 2 can travel in the traveling area 10. The traveling area 10 includes a loading place 11, a soil discharging place 12, a parking place 13, an oil filling place 14, a traveling path 15, and an intersection 16.

The loading place 11 refers to an area where loading work for loading a cargo on the unmanned vehicle 2 is performed. When the loading work is performed, the dump body 23 is adjusted to have a loading posture. In the loading place 11, a loader 7 operates. Examples of the loader 7 include a hydraulic shovel. The driver boards the loader 7. The loader 7 is a manned vehicle that operates based on a driving operation of the driver.

The soil discharging place 12 refers to an area where discharging work of discharging a cargo from the unmanned vehicle 2 is performed. When the discharging work is performed, the dump body 23 is adjusted to have a dumping posture. A crusher 8 is provided in the soil discharging place 12.

The parking place 13 is an area where the unmanned vehicle 2 is parked.

The oil filling place 14 is an area where the unmanned vehicle 2 is filled with oil.

The traveling path 15 refers to an area where the unmanned vehicle 2 travels toward at least one of the loading place 11, the soil discharging place 12, the parking place 13, and the oil filling place 14. The traveling path 15 is provided so as to connect at least the loading place 11 and the soil discharging place 12. In the embodiment, the traveling path 15 is connected to each of the loading place 11, the soil discharging place 12, the parking place 13, and the oil filling place 14.

The intersection 16 refers to an area where a plurality of traveling paths 15 intersects with each other or an area where one traveling path 15 branches into a plurality of traveling paths 15.

### Course Data

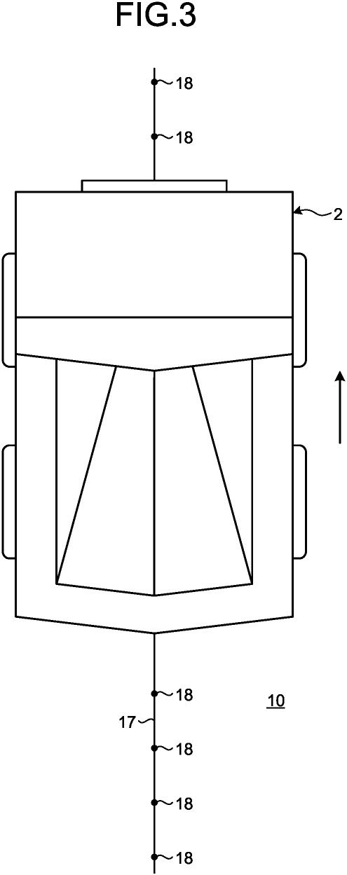

FIG. 3 is a schematic diagram for illustrating course data according to the embodiment. The management device 3 generates the course data. The course data indicates a traveling condition of the unmanned vehicle 2. The course data is set in the traveling area 10. The unmanned vehicle 2 travels in the traveling area 10 based on the course data transmitted from the management device 3. The course data includes course points 18, a traveling course 17 of the unmanned vehicle 2, target positions of the unmanned vehicle 2, target traveling speeds of the unmanned vehicle 2, target orientations of the unmanned vehicle 2, and terrains at the course points 18.

As illustrated in FIG. 3, a plurality of course points 18 is set in the traveling area 10. The course points 18 specify the target positions of the unmanned vehicle 2. The target traveling speeds of the unmanned vehicle 2 and the target orientations of the unmanned vehicle 2 are set at the plurality of course points 18. The plurality of course points 18 is set at intervals. The interval between the course points 18 is set to, for example, 1 [m] or more and 5 [m] or less. The intervals between the course points 18 may be uniform or non-uniform.

The traveling course 17 refers to a virtual line indicating a target traveling route of the unmanned vehicle 2. The traveling course 17 is specified by a track passing through the plurality of course points 18. The control device 40 controls the traveling device 22 so that the unmanned vehicle 2 travels along the traveling course 17. In the embodiment, the control device 40 controls the traveling device 22 so that the unmanned vehicle 2 travels with the center of the unmanned vehicle 2 in a vehicle width direction coinciding with the traveling course 17.

The target positions of the unmanned vehicle 2 refer to target positions of the unmanned vehicle 2 at the time when the unmanned vehicle 2 passes through the course points 18. The control device 40 controls the traveling device 22 so that actual positions of the unmanned vehicle 2 at the time when the unmanned vehicle 2 passes through the course points 18 correspond to the target positions based on detection data of the position sensor 31. The control device 40 controls the traveling device 22 so that the unmanned vehicle 2 travels along the traveling course 17 based on the detection data of the position sensor 31. The target positions of the unmanned vehicle 2 may be specified in a local coordinate system of the unmanned vehicle 2 or a global coordinate system.

The target traveling speeds of the unmanned vehicle 2 refer to target traveling speeds of the unmanned vehicle 2 at the time when the unmanned vehicle 2 passes through the course points 18. The control device 40 controls the traveling device 22 so that actual traveling speeds of the unmanned vehicle 2 at the time when the unmanned vehicle 2 passes through the course points 18 correspond to the target traveling speeds based on detection data of the speed sensor 32.

The target orientations of the unmanned vehicle 2 refer to target orientations of the unmanned vehicle 2 at the time when the unmanned vehicle 2 passes through the course points 18. The control device 40 controls the traveling device 22 so that actual orientations of the unmanned vehicle 2 at the time when the unmanned vehicle 2 passes through the course points 18 correspond to the target orientations.

The terrains at the course points 18 refer to inclination angles of the surfaces of the traveling area 10 at the course points 18. The control device 40 calculates the postures of the unmanned vehicle 2 at the course points 18 based on detection data of the inclination sensor 33 and the terrains of the course points 18 at the time when the unmanned vehicle 2 passes through the course points 18.

As illustrated in FIG. 2, in the embodiment, the traveling course 17 includes a first traveling course 17A and a second traveling course 17B. The unmanned vehicle 2 travels from the loading place 11 to the soil discharging place 12 along the first traveling course 17A, and travels from the soil discharging place 12 to the loading place 11 along the second traveling course 17B.

### Operation of Unmanned Vehicle in Loading Place

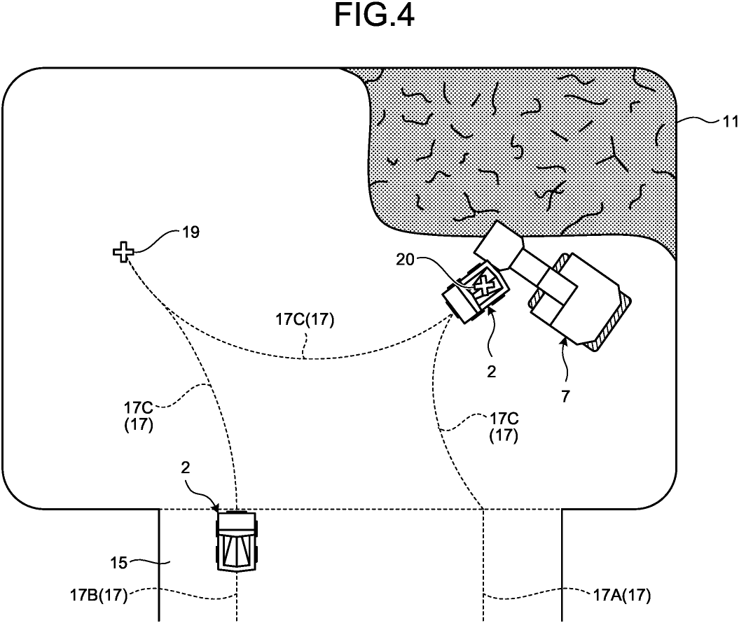

FIG. 4 is a schematic diagram for illustrating the operation of the unmanned vehicle 2 in the loading place 11 according to the embodiment. Loading work is performed in the loading place 11. The loader 7 is disposed in the loading place 11. The traveling path 15 is connected to the loading place 11. The first traveling course 17A and the second traveling course 17B are set in the traveling path 15. A third traveling course 17C is set in the loading place 11.

The management device 3 sets a switchback point 19 in the loading place 11. Furthermore, the management device 3 sets a loading point 20 in the loading place 11. The switchback point 19 refers to a target position at which the unmanned vehicle 2 is switched back. The loading point 20 refers to a target position of the unmanned vehicle 2 at the time when the loader 7 performs the loading work. The switchback refers to an operation in which the unmanned vehicle 2 moving forward changes an advancing direction thereof and enters the loading point 20 while moving backward. Note that a driver of the loader 7 may set at least one of the switchback point 19 and the loading point 20. The driver of the loader 7 can set at least one of the switchback point 19 and the loading point 20 by operating an operation device mounted on the loader 7.

The unmanned vehicle 2 enters the loading place 11 from the traveling path 15. The unmanned vehicle 2 enters the loading place 11 while moving forward. The unmanned vehicle 2 travels in the loading place 11 along the third traveling course 17C. The unmanned vehicle 2 that has entered the loading place 11 enters the switchback point 19 while moving forward, is stopped at the switchback point 19, and then enters the loading point 20 while moving backward. The unmanned vehicle 2 that has entered the loading point 20 is stopped at the loading point 20. The loading work is performed for the unmanned vehicle 2 disposed at the loading point 20. The unmanned vehicle 2 for which the loading work has ended exits from the loading point 20 while moving forward. The unmanned vehicle 2 that has exited from the loading point 20 exits from the loading place 11 to the traveling path 15.

### Control System

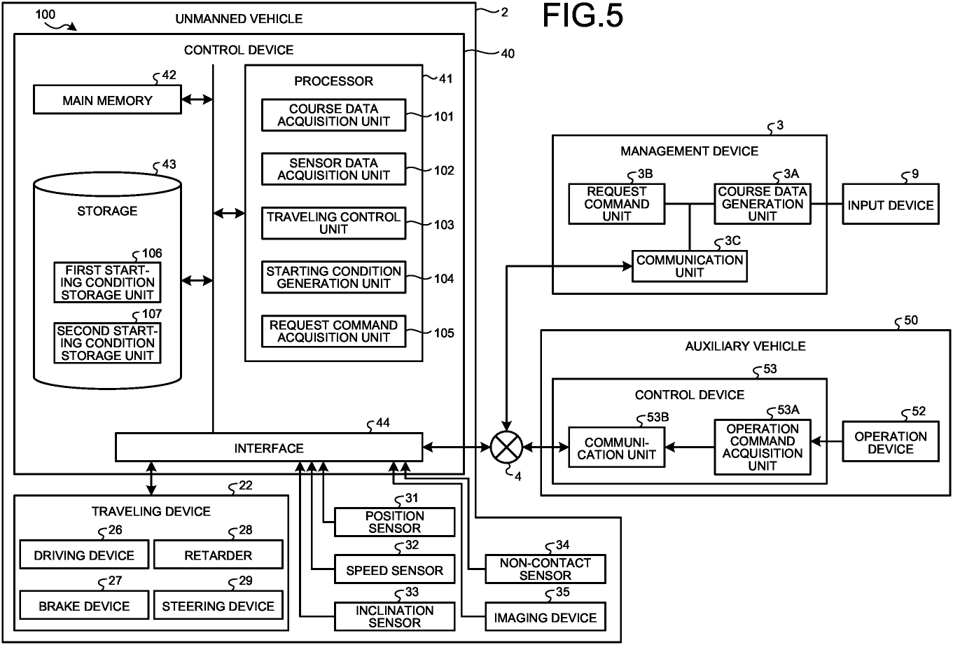

FIG. 5 is a functional block diagram illustrating a control system 100 of the unmanned vehicle 2 according to the embodiment. The control system 100 includes the control device 40 and the traveling device 22. The management device 3, the control device 40 of the unmanned vehicle 2, and the control device 53 of the auxiliary vehicle 50 wirelessly communicate with each other via the communication system 4.

The control device 40 includes a processor 41, a main memory 42, a storage 43, and an interface 44. Examples of the processor 41 include a central processing unit (CPU) and a micro processing unit (MPU). Examples of the main memory 42 include a nonvolatile memory and a volatile memory. Examples of the nonvolatile memory include a read only memory (ROM). Examples of the volatile memory include a random access memory (RAM). Examples of the storage 43 include a hard disk drive (HDD) and a solid state drive (SSD). Examples of the interface 44 include an input/output circuit and a communication circuit.

The interface 44 is connected to each of the traveling device 22, the position sensor 31, the speed sensor 32, the inclination sensor 33, the non-contact sensor 34, and the imaging devices 35. The interface 44 communicates with each of the traveling device 22, the position sensor 31, the speed sensor 32, the inclination sensor 33, the non-contact sensor 34, and the imaging devices 35.

The control device 40 includes a course data acquisition unit 101, a sensor data acquisition unit 102, a traveling control unit 103, a starting condition generation unit 104, a request command acquisition unit 105, a first starting condition storage unit 106, and a second starting condition storage unit 107. The processor 41 functions as the course data acquisition unit 101, the sensor data acquisition unit 102, the traveling control unit 103, the starting condition generation unit 104, and the request command acquisition unit 105. The storage 43 functions as the first starting condition storage unit 106 and the second starting condition storage unit 107.

The course data acquisition unit 101 acquires course data transmitted from the management device 3 via the interface 44.

The sensor data acquisition unit 102 acquires detection data of the position sensor 31, detection data of the speed sensor 32, detection data of the inclination sensor 33, detection data of the non-contact sensor 34, and image data on the surroundings of the unmanned vehicle 2 obtained by the imaging devices 35.

The traveling control unit 103 controls the traveling device 22 based on the course data acquired by the course data acquisition unit 101. Furthermore, the traveling control unit 103 performs starting control for the unmanned vehicle 2. The starting control refers to control for starting the stopped unmanned vehicle 2.

The starting condition generation unit 104 generates a starting condition used for the starting control for the unmanned vehicle 2. The starting condition includes a control program related to the starting control. In the embodiment, the starting condition includes a first starting condition and a second starting condition. The starting condition generation unit 104 generates the first starting condition and the second starting condition.

The first starting condition storage unit 106 stores the first starting condition generated by the starting condition generation unit 104. The second starting condition storage unit 107 stores the second starting condition generated by the starting condition generation unit 104.

The traveling control unit 103 performs the starting control for the unmanned vehicle 2 based on the starting condition generated by the starting condition generation unit 104.

The request command acquisition unit 105 acquires a request command for requesting a change from the starting control using the first starting condition to the starting control using the second starting condition. The request command is transmitted from the management device 3 to the control device 40. The traveling control unit 103 performs the starting control using the second starting condition based on the request command.

The control device 53 of the auxiliary vehicle 50 includes an operation command acquisition unit 53A and a communication unit 53B.

The operation device 52 is mounted on the auxiliary vehicle 50. When operated by a driver, the operation device 52 generates an operation command. The operation command acquisition unit 53A acquires the operation command generated by the operation device 52.

The operation command generated by the operation device 52 includes the request command for requesting a change from the starting control using the first starting condition to the starting control using the second starting condition. The operation device 52 generates the request command. The operation command acquisition unit 53A acquires the request command generated by the operation device 52. The operation command acquisition unit 53A transmits the request command to the management device 3 via the communication unit 53B and the communication system 4.

The management device 3 includes a course data generation unit 3A, a request command unit 3B, and a communication unit 3C.

The course data generation unit 3A generates course data indicating a traveling condition of the unmanned vehicle 2. An administrator of the control facility 5 operates an input device 9 connected to the management device 3 to input the traveling condition of the unmanned vehicle 2 to the management device 3. Examples of the input device 9 include a touch panel, a computer keyboard, a mouse, and an operation button. The input device 9 is operated by the administrator to generate input data. The course data generation unit 3A generates course data based on the input data generated by the input device 9. The course data generation unit 3A transmits the course data to the unmanned vehicle 2 via the communication unit 3C and the communication system 4.

The request command unit 3B acquires a request command from the auxiliary vehicle 50 via the communication system 4 and the communication unit 3C. The request command unit 3B transmits the request command to the unmanned vehicle 2 via the communication unit 3C and the communication system 4.

### Starting Condition

Next, the starting condition will be described. The starting condition indicates the relation between a control command related to the starting control and a time elapsed since start time of the starting control. The starting condition includes the first starting condition and the second starting condition. One of the first starting condition and the second starting condition is selected based on the state of the unmanned vehicle 2. The traveling control unit 103 performs the starting control based on the selected starting condition.

The state of the unmanned vehicle 2 includes a normal state and an abnormal state. In the embodiment, the normal state of the unmanned vehicle 2 includes a state in which the lower ends 60 of the tires 25 are in contact with a road surface 61. The abnormal state of the unmanned vehicle 2 includes a state in which at least a part of the tires 25 is buried below the road surface 61 or enters a groove of the road surface 61. When the unmanned vehicle 2 is in the normal state, the first starting condition is selected. When the unmanned vehicle 2 is in the abnormal state, the second starting condition is selected.

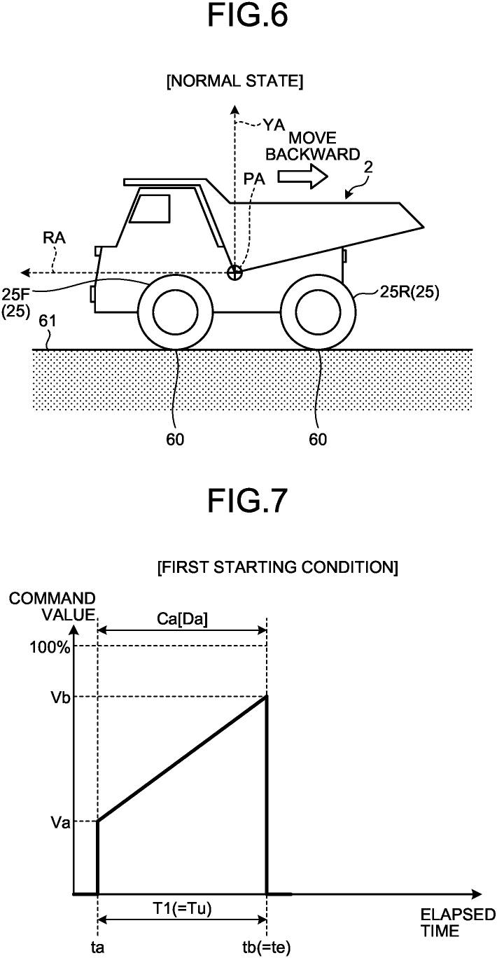

FIG. 6 illustrates one example of the unmanned vehicle 2 in the normal state according to the embodiment. FIG. 7 illustrates the first starting condition according to the embodiment.

The first starting condition is used when the unmanned vehicle 2 is in the normal state. As illustrated in FIG. 6, a state in which the unmanned vehicle 2 is in the normal state refers to a state in which the lower ends 60 of the tires 25 are in contact with the road surface 61. That is, a state in which the unmanned vehicle 2 is in the normal state refers to a state in which at least a part of the tires 25 is not buried below the road surface 61, or at least a part of the tires 25 does not enter a groove of the road surface 61. When the road surface 61 is solid, the unmanned vehicle 2 is highly likely to be in the normal state.

In the embodiment, the first starting condition is used when the unmanned vehicle 2 in the normal state starts in a horizontal posture or a climbing posture. The horizontal posture refers to a posture in which each of the pitch angle Pθ and the roll angle Rθ is 0[°]. That is, the horizontal posture refers to a posture in which each of the pitch axis PA and the roll axis RA is parallel to the horizontal plane. The climbing posture refers to a posture in which the pitch angle Pθ is larger than 0[°]. That is, the climbing posture refers to a posture in which the roll axis RA is inclined with respect to the horizontal plane. A posture in which the lower ends 60 of the front tires 25F and the lower ends 60 of the rear tires 25R are disposed at substantially the same height is the horizontal posture. In the unmanned vehicle 2 moving forward, a posture in which the lower ends 60 of the front tires 25F are disposed at positions higher than those of the lower ends 60 of the rear tires 25R is the climbing posture. In the unmanned vehicle 2 moving backward, a posture in which the lower ends 60 of the rear tires 25R are disposed at positions higher than those of the lower ends 60 of the front tires 25F is the climbing posture.

The inclination sensor 33 detects the pitch angle Pθ and the roll angle Rθ indicating the posture of the unmanned vehicle 2. Forward movement or backward movement indicating an advancing direction of the unmanned vehicle 2 is specified by the course data. The traveling control unit 103 can determine whether or not the unmanned vehicle 2 starts in the horizontal posture or the climbing posture based on the course data acquired by the course data acquisition unit 101 and the detection data of the inclination sensor 33 acquired by the sensor data acquisition unit 102. In the embodiment, the traveling control unit 103 calculates the posture of the unmanned vehicle 2 based on the detection data of the inclination sensor 33 and the terrain specified by the course data, and determines whether or not the unmanned vehicle 2 starts in the horizontal posture or the climbing posture.

As described above, when entering the loading point 20 from the switchback point 19 in the loading place 11, the unmanned vehicle 2 starts to move backward from the stopped state. When the loading work ends and the unmanned vehicle 2 exits from the loading point 20, the unmanned vehicle 2 starts to move forward from the stopped state. When the unmanned vehicle 2 moves forward or backward from the stopped state with the lower ends 60 of the front tires 25F and the lower ends 60 of the rear tires 25R being disposed at the same height, the traveling control unit 103 determines that the unmanned vehicle 2 starts in the horizontal posture. When the unmanned vehicle 2 moves forward from the stopped state with the lower ends 60 of the front tires 25F being disposed at higher positions than the lower ends 60 of the rear tires 25R, the traveling control unit 103 determines that the unmanned vehicle 2 starts in the climbing posture. When the unmanned vehicle 2 moves backward from the stopped state with the lower ends 60 of the rear tires 25R being disposed at higher positions than the lower ends 60 of the front tires 25F, the traveling control unit 103 determines that the unmanned vehicle 2 starts in the climbing posture.

As illustrated in FIG. 7, when the unmanned vehicle 2 is started in the normal state, the traveling control unit 103 outputs a first command Ca. The first command Ca is a control command for starting the unmanned vehicle 2 in the normal state. In FIG. 7, the vertical axis represents a command value of the first command Ca, and the horizontal axis represents a time elapsed since a time point ta at which output of the first command Ca is started. The time point ta is start time of the starting control in accordance with the first command Ca. The first starting condition indicates the relation between the first command Ca for starting the unmanned vehicle 2 in the normal state and the time elapsed since the time point ta of the starting control. The first command Ca is output only during a first time T1 from the time point ta to a time point tb. The time point tb is end time of the starting control in accordance with the first command Ca.

In the embodiment, the first command Ca includes a normal driving command for causing the driving device 26 of the unmanned vehicle 2 to generate normal driving force Da.

A larger command value of the first command Ca causes the driving device 26 to generate larger driving force. A smaller command value of the first command Ca causes the driving device 26 to generate smaller driving force. When a command value is 100[%], the driving device 26 outputs a maximum value of driving force which can be generated by the driving device 26. That is, when the command value is 100[%], the driving device 26 operates in a full accelerator state.

In the example in FIG. 7, the first starting condition is set such that the command value of the first command Ca does not reach 100[%]. Under the first starting condition, the command value at the time point ta is set to a command value Va smaller than 50[%]. Note that the command value Va at the time point ta may be 50[%] or larger than 50[%]. The command value at the time point tb is set to a command value Vb which is larger than the command value Va and smaller than 100[%]. Under the first starting condition, the command value of the first command Ca is set to gradually increase from the command value Va to the command value Vb. The command value of the first command Ca monotonically increases with respect to an elapsed time. Output of the first command Ca is stopped at the time point tb at which the first time T1 has elapsed since the start of output of the first command Ca.

The starting condition generation unit 104 calculates the command value Va of the first command Ca such that the stopped unmanned vehicle 2 starts at the time point ta. The starting condition generation unit 104 calculates a target acceleration of the unmanned vehicle 2 based on the target traveling speed of the unmanned vehicle 2 specified by the course data. The starting condition generation unit 104 calculates target driving force of the driving device 26 that generates the target acceleration based on an equation of motion obtained by modeling each of the unmanned vehicle 2 and the traveling area 10. Correlation data (table) indicating the relation between the target driving force and the command value is preliminarily determined. The starting condition generation unit 104 determines the command value Va for generating the target driving force at the time point ta based on the correlation data.

When starting control is performed based on the first starting condition, the traveling control unit 103 starts output of the first command Ca at the time point ta. The output of the first command Ca allows the unmanned vehicle 2 to start. The traveling control unit 103 monotonically increases the command value of the first command Ca with respect to a time elapsed since the start of the output of the first command Ca. The driving device 26 generates the normal driving force Da based on the first command Ca.

Note that the command value Va at the time point ta is a theoretical value calculated based on the above-described equation of motion. For example, even if the output of the first command Ca is started, the unmanned vehicle 2 may fail to start at the time point ta depending on an actual state of the unmanned vehicle 2 or an actual state of the traveling area 10. In the embodiment, the command value of the first command Ca monotonically increases from the time point ta, so that the unmanned vehicle 2 can start at the first time T1.

The traveling control unit 103 can determine whether or not the unmanned vehicle 2 has started based on the detection data of the speed sensor 32. When the first time T1 elapses, the traveling control unit 103 stops the output of the first command Ca. When the unmanned vehicle 2 does not start even after the first time T1 elapses, the traveling control unit 103 outputs an error signal, and then stops the output of the first command Ca. When the unmanned vehicle 2 does not start even after the first time T1 elapses, the output of the first command Ca is stopped, so that an excessive load is inhibited from acting on the driving device 26.

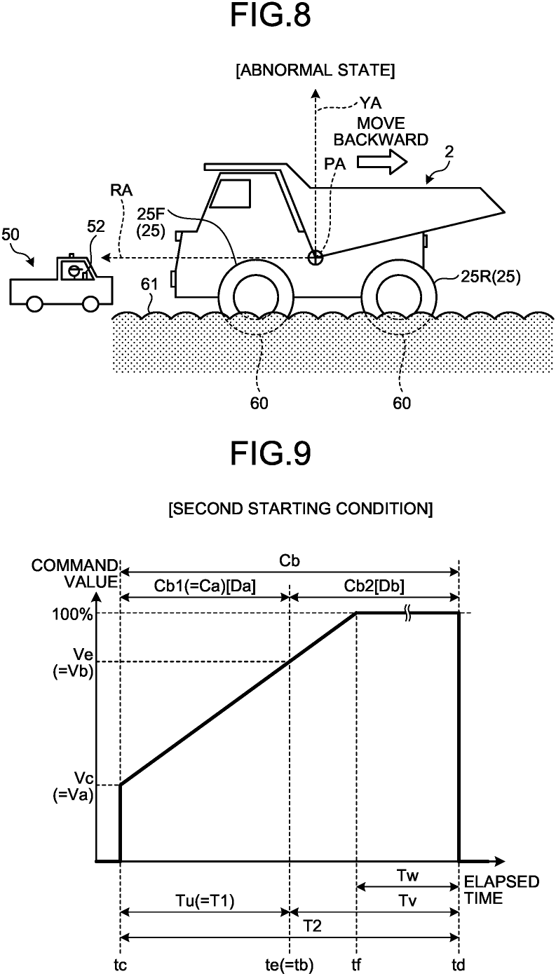

FIG. 8 illustrates one example of the unmanned vehicle 2 in the abnormal state according to the embodiment. FIG. 9 illustrates the second starting condition according to the embodiment.

The second starting condition is used when the unmanned vehicle 2 is in the abnormal state. As illustrated in FIG. 8, when the unmanned vehicle 2 is in the abnormal state, at least a part of the tires 25 is buried below the road surface 61, or at least a part of the tires 25 enters a groove of the road surface 61. When the road surface 61 is soft, the unmanned vehicle 2 is highly likely to be in the abnormal state. Examples of the soft road surface 61 include a road surface of oil sands or a road surface that is muddy due to rainwater.

In the embodiment, the second starting condition is used when the unmanned vehicle 2 in the abnormal state starts in the horizontal posture or the climbing posture. The traveling control unit 103 can determine whether or not the unmanned vehicle 2 starts in the horizontal posture or the climbing posture based on the course data acquired by the course data acquisition unit 101 and the detection data of the inclination sensor 33 acquired by the sensor data acquisition unit 102.

As illustrated in FIG. 9, when the unmanned vehicle 2 in the abnormal state is started, the traveling control unit 103 outputs a second command Cb. The second command Cb is a control command for starting the unmanned vehicle 2 in the abnormal state. In FIG. 9, the vertical axis represents a command value of the second command Cb, and the horizontal axis represents a time elapsed since a time point tc at which output of the second command Cb is started. The time point tc is start time of the starting control in accordance with the second command Cb. The second starting condition indicates the relation between the second command Cb for starting the unmanned vehicle 2 in the abnormal state and the time elapsed since the time point tc of the starting control. The second command Cb is output only during a second time T2 from the time point tc to a time point td. The time point td is end time of the starting control in accordance with the second command Cb. The second time T2 is longer than the first time T1. The second command Cb is output during the second time T2. The first command Ca is output during the first time T1.

In the embodiment, the second command Cb includes an initial command Cb1 and an assist driving command Cb2. The initial command Cb1 is the same as the first command Ca output in an initial time Tu of the first time T1. The assist driving command Cb2 causes the unmanned vehicle 2 to generate assist driving force Db.

The initial time Tu of the first time T1 refers to a time from the time point ta to a specified time point te under the first starting condition described with reference to FIG. 7. The specified time point te may be set between the time point ta and the time point tb, or may be the same as the time point tb. When the specified time point te is set between the time point ta and the time point tb, the initial command Cb1 is the same as a part of the first command Ca. When the specified time point te is the same as the time point tb, the initial command Cb1 is the same as the first command Ca.

The first command Ca and the initial command Cb1 being the same means that a command value at the time point ta is the same as a command value at the time point tc, and that the increase rates or the decrease rates of the command values are the same. The increase rates of command values refer to increase amounts of the command values per unit time. The decrease rates of command values refer to decrease amounts of the command values per unit time.

In the embodiment, the specified time point te is the same as the time point tb. That is, in the embodiment, the initial command Cb1 is the same as the first command Ca. Under the second starting condition, a command value Vc at the time point tc at which output of the initial command Cb1 is started is the same as the command value Va. A command value Ve at the specified time point te at which the output of the initial command Cb1 ends is the same as the command value Vb.

The output of the initial command Cb1 causes the driving device 26 to generate the normal driving force Da during the initial time Tu.

The assist driving command Cb2 is output after the initial command Cb1 is output. The assist driving command Cb2 is output only during an assist time Tv from the specified time point te to the time point td. The second time T2 includes the initial time Tu and the assist time Tv. The initial command Cb1 (normal driving command) is output during the initial time Tu. The assist driving command Cb2 is output during the assist time Tv. The assist time Tv is set after the initial time Tu.

The second starting condition is set such that the command value of the second command Cb reaches 100[%]. Under the second starting condition, the command value Vc at the time point tc is the same as the command value Va. The command value Ve at the specified time point te is the same as the command value Vb. A command value at a time point tf between the specified time point te and the time point td is set to 100[%]. The command value of the second command Cb is set to gradually increase from the command value Ve to 100[%] between the specified time point te and the time point tf. The command value of the second command Cb monotonically increases with respect to an elapsed time. The increase rate of the command value between the time point tc and the specified time point te is the same as the increase rate of the command value between the specified time point te and the time point tf. The command value is maintained at 100[%] during a maximum output time Tw between the time point tf and the time point td. Output of the second command Cb is stopped at the time point td at which the second time T2 has elapsed since the start of output of the second command Cb.

As illustrated in FIG. 9, the command value of the assist driving command Cb2 is larger than the command value of the initial command Cb1 (normal driving command). That is, the assist driving force Db is larger than the normal driving force Da. The driving device 26 generates the assist driving force Db in accordance with the assist driving command Cb2. The driving device 26 generates the normal driving force Da in accordance with the initial command Cb1 (normal driving command). The maximum value of the command value of the second command Cb is 100[%]. That is, the maximum value of the assist driving force Db is the maximum value of driving force that can be generated by the driving device 26 of the unmanned vehicle 2.

The maximum output time Tw is longer than the first time T1. The first time T1 is, for example, 15 [sec.]. The maximum output time Tw is, for example, 40 [sec.].

When starting control is performed based on the second starting condition, the traveling control unit 103 starts output of the second command Cb at the time point tc. The traveling control unit 103 monotonically increases the command value of the second command Cb with respect to a time elapsed since the start of the output of the second command Cb between the time point tc and the time point tf. The traveling control unit 103 maintains the command value of the second command Cb at 100[%] between the time point tf and the time point td. The driving device 26 generates the normal driving force Da and the assist driving force Db based on the second command Cb.

When the unmanned vehicle 2 is in the abnormal state, the traveling control unit 103 outputs the second command Cb that causes the unmanned vehicle 2 to generate the assist driving force Db. The assist driving force Db is larger than the normal driving force Da. Furthermore, the second time T2 is longer than the first time T1. The second command Cb is output during the second time T2. Even when at least a part of the tires 25 is buried below the road surface 61 or even when at least a part of the tires 25 enters a groove of the road surface 61, the tires 25 escape from the road surface 61, and the unmanned vehicle 2 can start.

The traveling control unit 103 can determine whether or not the unmanned vehicle 2 has started based on the detection data of the speed sensor 32. When the second time T2 elapses, the traveling control unit 103 stops the output of the second command Cb. When the unmanned vehicle 2 does not start even after the second time T2 elapses, the traveling control unit 103 outputs an error signal, and then stops the output of the second command Cb.

### Selection of First Starting Condition and Second Starting Condition

In the embodiment, when the unmanned vehicle 2 is determined not to be started by the first command Ca, the traveling control unit 103 outputs the second command Cb that causes the driving device 26 of the unmanned vehicle 2 to generate the assist driving force Db.

In the embodiment, a driver of the auxiliary vehicle 50 determines the state of the unmanned vehicle 2. The driver checks the unmanned vehicle 2, and determines which of the normal state or the abnormal state the unmanned vehicle 2 is in. When the unmanned vehicle 2 is in the abnormal state and the first command Ca is determined not to be able to start the unmanned vehicle 2, the driver operates the operation device 52 to change the output of the first command Ca to the output of the second command Cb. An operation command output from the operation device 52 includes a request command for requesting a change from the output of the first command Ca to the output of the second command Cb. The request command is generated by an operation of the operation device 52 mounted on the auxiliary vehicle 50. The operation command acquisition unit 53A acquires the request command generated by the operation device 52. The operation command acquisition unit 53A transmits the request command to the management device 3 via the communication unit 53B and the communication system 4.

The request command unit 3B of the management device 3 acquires the request command generated by the operation device 52 of the auxiliary vehicle 50 being operated via the communication system 4 and the communication unit 3C. The request command unit 3B transmits the request command to the unmanned vehicle 2 via the communication unit 3C and the communication system 4. The control device 40 of the unmanned vehicle 2 receives the request command. The request command acquisition unit 105 acquires the request command for requesting a change from the output of the first command Ca to the output of the second command Cb. The traveling control unit 103 outputs the second command Cb based on the request command acquired by the request command acquisition unit 105. That is, the traveling control unit 103 performs the starting control using the second starting condition based on the request command.

### Control Method

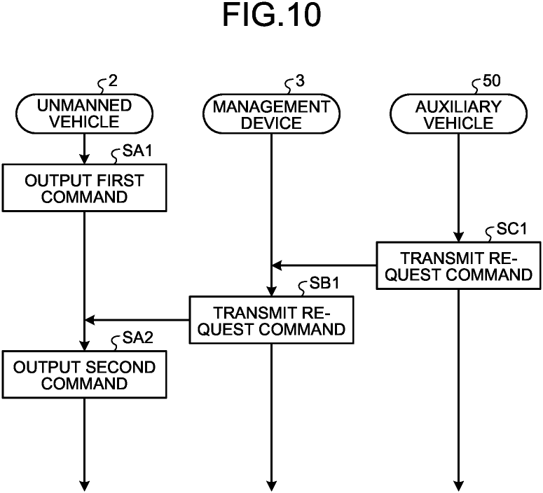

FIG. 10 is a flowchart illustrating a method of controlling the unmanned vehicle 2 according to the embodiment. Starting control at the time when the unmanned vehicle 2 that has switched back in the loading place 11 starts to move backward will be described below.

The unmanned vehicle 2 enters the loading place 11 from the traveling path 15. The unmanned vehicle 2 enters the loading place 11 while moving forward. The unmanned vehicle 2 that has entered the switchback point 19 while moving forward is stopped at the switchback point 19, and then starts to move backward to enter the loading point 20.

The traveling control unit 103 outputs the first command Ca to the driving device 26 in order to start the backward movement of the unmanned vehicle 2 (Step SA1).

When the unmanned vehicle 2 is in the normal state, the unmanned vehicle 2 can start to move backward by the first command Ca being output from the traveling control unit 103 to the driving device 26.

When the unmanned vehicle 2 is in the abnormal state, the unmanned vehicle 2 may fail to start even if the first command Ca is output from the traveling control unit 103 to the driving device 26. When the unmanned vehicle 2 does not start even if the first command Ca has been output and the first time T1 elapses, the traveling control unit 103 outputs an error signal. The error signal is transmitted to the auxiliary vehicle 50 via the management device 3. The error signal is output from an output device mounted on the auxiliary vehicle 50. Examples of the output device include a display device and a voice output device. The error signal output from the output device allows the driver of the auxiliary vehicle 50 to recognize the presence of the unmanned vehicle 2 that was not started by the first command Ca.

When the unmanned vehicle 2 is determined not to be started by the first command Ca, the driver operates the operation device 52 mounted on the auxiliary vehicle 50 to generate the request command for requesting a change from the output of the first command Ca to the output of the second command Cb.

The operation command acquisition unit 53A acquires the request command generated by the operation of the operation device 52. The operation command acquisition unit 53A transmits the request command to the management device 3 (Step SC1).

The request command unit 3B receives the request command transmitted from the control device 53. The request command unit 3B transmits the request command to the unmanned vehicle 2 (Step SB1).

The request command acquisition unit 105 receives the request command transmitted from the management device 3. The traveling control unit 103 outputs the second command Cb to the driving device 26 based on the request command acquired by the request command acquisition unit 105 (Step SA2).

The second command Cb includes the assist driving command Cb2 for causing the driving device 26 of the unmanned vehicle 2 to generate the assist driving force Db. Since the driving device 26 generates the normal driving force Da and the assist driving force Db, the unmanned vehicle 2 that was not successfully started only by the normal driving force Da can start. Furthermore, the assist driving force Db is larger than the normal driving force Da. Therefore, the unmanned vehicle 2 stopped at the switchback point 19 can start.

### Effects

As described above, according to the embodiment, when the unmanned vehicle 2 is determined not to be started by the first command Ca, the traveling control unit 103 outputs the second command Cb that causes the unmanned vehicle 2 to generate the assist driving force Db. Adding the assist driving force Db to the normal driving force Da allows the unmanned vehicle 2 that was not successfully started by the first command Ca to start based on the second command Cb. The unmanned vehicle 2 can start, so that a decrease in productivity of the work site is inhibited.

The first command Ca includes the normal driving command for causing the unmanned vehicle 2 to generate the normal driving force Da. The assist driving force Db is larger than the normal driving force Da. This allows the unmanned vehicle 2 that was not successfully started by the first command Ca to start based on the second command Cb.

The second command Cb includes the initial command Cb1 and the assist driving command Cb2. The initial command Cb1 is the same as the normal driving command output during the initial time Tu from the time point ta to the specified time point te under the first starting condition. The assist driving command Cb2 is output during the assist time Tv from the specified time point te to the time point td. That is, the second time T2 under the second starting condition includes the initial time Tu and the assist time Tv. The normal driving force Da equivalent to that under the first starting condition is generated during the initial time Tu. The assist driving force Db added after the initial time Tu is generated during the assist time Tv. The driving device 26 generates the assist driving force Db after generating the normal driving force Da. This allows the unmanned vehicle 2 that was not successfully started by the normal driving force Da to start based on the assist driving force Db.

Furthermore, the initial command Cb1 is the same as a part or all of the first command Ca. That is, the command value Vc of the second command Cb is the same as the command value Va, and the increase rate of the command value of the second command Cb from the time point tc to the specified time point te is the same as the increase rate of the command value of the first command Ca. Thus, when the second command Cb is output even though the unmanned vehicle 2 is in the normal state, the sudden start of the unmanned vehicle 2 is inhibited.

The second command Cb is continuously output only for the second time T2, which is longer than the first time T1 during which the first command Ca is output. This causes the driving force generated by the driving device 26 to be continuously transmitted to the tires 25 for a long time. Therefore, the unmanned vehicle 2 in the abnormal state can start.

The maximum value of the assist driving force Db is the maximum value of driving force that can be generated by the driving device 26 of the unmanned vehicle 2. This allows the unmanned vehicle 2 in the abnormal state to start. Under the first starting condition, the normal driving force Da is smaller than the maximum value of the driving force that can be generated by the driving device 26 of the unmanned vehicle 2. When the unmanned vehicle 2 is in the normal state, the unmanned vehicle 2 can start even when the driving device 26 is not in the full accelerator state. When the unmanned vehicle 2 is in the normal state, the driving device 26 is not in the full accelerator state, so that energy consumption of the unmanned vehicle 2 is inhibited. Furthermore, when the unmanned vehicle 2 is in the normal state, the driving device 26 is not in the full accelerator state, so that an excessive load is inhibited from acting on the driving device 26. Furthermore, when the unmanned vehicle 2 is in the normal state, the driving device 26 is not in the full accelerator state, so that the unmanned vehicle 2 is inhibited from forcibly passing over an obstacle, for example.

The request command for requesting a change from the output of the first command Ca to the output of the second command Cb is transmitted to the control device 40. The request command acquisition unit 105 acquires the request command. The traveling control unit 103 outputs the second command Cb based on the request command. This allows the unmanned vehicle 2 in the abnormal state to start based on the request command.

The request command is generated by an operation of the operation device 52 mounted on the auxiliary vehicle 50. This causes the second command Cb to be output after the driver objectively determines whether or not the first command Ca can start the unmanned vehicle 2. Furthermore, the driver can start the unmanned vehicle 2 based on the second command Cb after checking the situation around the unmanned vehicle 2.

### Other Examples

In the above-described embodiment, the request command generated by the operation device 52 is transmitted to the unmanned vehicle 2 via the management device 3. The request command generated by the operation device 52 may be transmitted to the unmanned vehicle 2 without passing through the management device 3.

In the above-described embodiment, as described with reference to FIG. 10, after the first command Ca is output (Step SA1), the second command Cb is output (Step SA2). When the first command Ca is determined not to be able to start the unmanned vehicle 2 before the traveling control unit 103 outputs the first command Ca, the request command may be transmitted to the unmanned vehicle 2. The traveling control unit 103 may output the second command Cb based on the request command without outputting the first command Ca.

In the above-described embodiment, the request command is generated by the operation device 52 mounted on the auxiliary vehicle 50 being operated. When the unmanned vehicle 2 cannot start in the loading place 11, the request command may be output from the loader 7. The request command may be generated by an operation device being mounted on the loader 7 and the operation device being operated by the driver of the loader 7. The request command may be output from a mobile terminal carried by the driver.

In the above-described embodiment, the second command Cb includes the initial command Cb1 and the assist driving command Cb2. The initial command Cb1 is the same as at least a part of the first command Ca. The assist driving command Cb2 is output after the initial command Cb1. The second command Cb is not required to include the initial command Cb1. The second command Cb is only required to generate the assist driving force Db larger than the normal driving force Da. Furthermore, the second command Cb is only required to be output only for the second time T2, which is longer than the first time T1.

In the above-described embodiment, the assist driving force Db is larger than the normal driving force Da. The assist driving force Db and the normal driving force Da may be equal to each other. Furthermore, the maximum value of the normal driving force Da is the maximum value of driving force that can be generated by the driving device 26 of the unmanned vehicle 2. That is, at least a part of the command value of the first command Ca may be 100[%]. Even when the assist driving force Db and the normal driving force Da are equal to each other, the unmanned vehicle 2 that was not successfully started by the first command Ca can start based on the second command Cb since the second time T2 is longer than the first time T1.

In the above-described embodiment, the maximum value of the assist driving force Db is the maximum value of driving force that can be generated by the driving device 26 of the unmanned vehicle 2. The maximum value of the assist driving force Db may be smaller than the maximum value of driving force that can be generated by the driving device 26 of the unmanned vehicle 2. That is, the command value of the assist driving command Cb2 may be smaller than 100[%].

In the above-described embodiment, the command value Va at the time point ta is only required to be larger than 0[%]. The command value Va at the time point ta may be 100[%].

In the above-described embodiment, the command value Vb at the time point tb is larger than the command value Va and smaller than 100[%]. The command value Vb at the time point tb may be 100[%].

In the above-described embodiment, the command value of the first command Ca monotonically increases with respect to an elapsed time. The command value of the first command Ca may be constant with respect to the elapsed time.

In the above-described embodiment, the increase rate of the command value between the time point tc and the specified time point te is the same as the increase rate of the command value between the specified time point te and the time point tf. The increase rate of the command value between the time point tc and the specified time point te may be different from the increase rate of the command value between the specified time point te and the time point tf. For example, the unmanned vehicle 2 that was not successfully started by the first command Ca can start early based on the second command Cb by making the increase rate of the command value between the specified time point te and the time point tf larger than the increase rate of the command value between the time point tc and the specified time point te.

### Second Embodiment

A second embodiment will be described. In the following description, the same or equivalent components as or to those of the above-described embodiment are denoted by the same reference signs, and the description of the components is simplified or omitted.

### Starting Condition

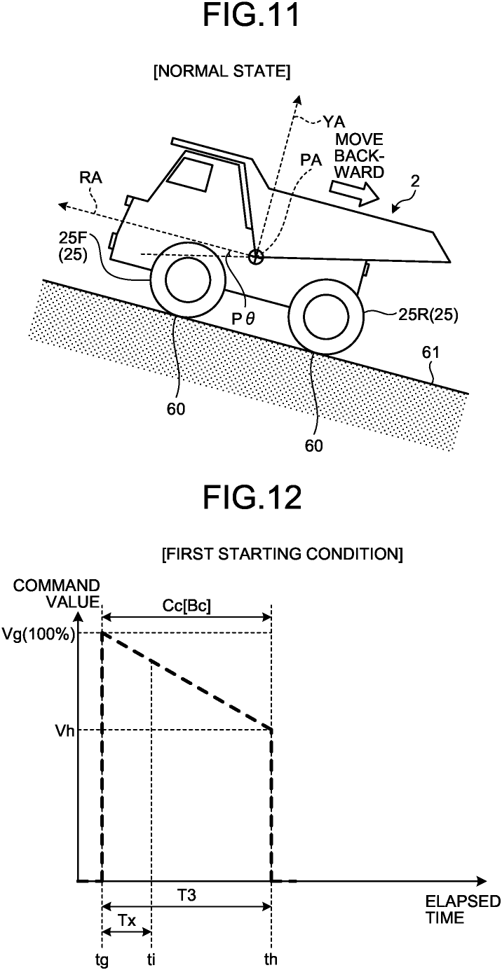

FIG. 11 illustrates one example of the unmanned vehicle 2 in the normal state according to the embodiment. FIG. 12 illustrates the first starting condition according to the embodiment. Similarly to the above-described embodiment, the first starting condition is used when the unmanned vehicle 2 is in the normal state.

In the embodiment, the first starting condition is used when the unmanned vehicle 2 in the normal state starts in a downhill posture. As illustrated in FIG. 11, the downhill posture refers to a posture in which the pitch angle pθ is larger than 0[°]. That is, the downhill posture refers to a posture in which the roll axis RA is inclined with respect to the horizontal plane. In the unmanned vehicle 2 moving forward, a posture in which the lower ends 60 of the front tires 25F are disposed at positions lower than those of the lower ends 60 of the rear tires 25R is the downhill posture. In the unmanned vehicle 2 moving backward, a posture in which the lower ends 60 of the rear tires 25R are disposed at positions lower than those of the lower ends 60 of the front tires 25F is the downhill posture.

The inclination sensor 33 detects the pitch angle Pθ and the roll angle Rθ indicating the posture of the unmanned vehicle 2. Forward movement or backward movement indicating an advancing direction of the unmanned vehicle 2 is specified by the course data. The traveling control unit 103 can determine whether or not the unmanned vehicle 2 starts in the downhill posture based on the course data acquired by the course data acquisition unit 101 and the detection data of the inclination sensor 33 acquired by the sensor data acquisition unit 102. In the embodiment, the traveling control unit 103 calculates the posture of the unmanned vehicle 2 based on the detection data of the inclination sensor 33 and the terrain specified by the course data, and determines whether or not the unmanned vehicle 2 starts in the downhill posture.

When the unmanned vehicle 2 moves forward from the stopped state with the lower ends 60 of the front tires 25F being disposed at lower positions than the lower ends 60 of the rear tires 25R, the traveling control unit 103 determines that the unmanned vehicle 2 starts in the downhill posture. When the unmanned vehicle 2 moves backward from the stopped state with the lower ends 60 of the rear tires 25R being disposed at lower positions than the lower ends 60 of the front tires 25F, the traveling control unit 103 determines that the unmanned vehicle 2 starts in the downhill posture.

In the embodiment, when determining that the pitch angle Pθ is equal to or greater than a predetermined threshold based on the detection data of the inclination sensor 33, the traveling control unit 103 determines that the unmanned vehicle 2 is in the downhill posture. Note that, when the pitch angle Pθ is less than the threshold value, the traveling control unit 103 determines that the unmanned vehicle 2 is in the horizontal posture, and can perform the starting control under the starting condition described in the first embodiment.

As illustrated in FIG. 12, when the unmanned vehicle 2 is started in the normal state, the traveling control unit 103 outputs a first command Cc. In FIG. 12, the vertical axis represents a command value of the first command Cc, and the horizontal axis represents a time elapsed since a time point tg at which output of the first command Cc is started. The time point tg is start time of the starting control in accordance with the first command Cc. The first command Cc is output only during a first time T3 from the time point tg to a time point th. The time point th is end time of the starting control in accordance with the first command Cc.

In the embodiment, the first command Cc includes a braking release command for releasing braking force Bc generated by the retarder 28 of the unmanned vehicle 2.

A larger command value of the first command Cc causes the retarder 28 to generate larger braking force Bc. A smaller command value causes the retarder 28 to generate smaller braking force Bc. When a command value is 100[%], the retarder 28 outputs a maximum value of the braking force Bc which can be generated by the retarder 28. That is, when the command value is 100[%], the retarder 28 operates in a full brake state.

In the example in FIG. 12, the first starting condition is set such that the command value of the first command Cc decreases from 100[%]. Under the first starting condition, the command value at the time point tg is set to a command value Vg which is the same as 100[%]. The command value at the time point th is set to a command value Vh smaller than 100[%]. Under the first starting condition, the command value of the first command Cc is set to gradually decrease from the command value Vg to the command value Vh. The command value of the first command Cc monotonically decreases with respect to an elapsed time. Output of the first command Cc is stopped at the time point th at which the first time T3 has elapsed since the start of output of the first command Cc.

The starting condition generation unit 104 calculates the command value Vg of the first command Cc such that the stopped unmanned vehicle 2 starts at the time point tg. The starting condition generation unit 104 calculates a target acceleration of the unmanned vehicle 2 based on the target traveling speed of the unmanned vehicle 2 specified by the course data. The starting condition generation unit 104 calculates target braking force of the retarder 28 that generates the target acceleration based on an equation of motion obtained by modeling each of the unmanned vehicle 2 and the traveling area 10. Correlation data (table) indicating the relation between the target braking force and the command value is preliminarily determined. The starting condition generation unit 104 determines the command value Vg for generating the target braking force at the time point tg based on the correlation data.

When starting control is performed based on the first starting condition, the traveling control unit 103 starts output of the first command Cc at the time point tg. The output of the first command Cc allows the unmanned vehicle 2 to start. The traveling control unit 103 monotonically decreases the command value of the first command Cc with respect to a time elapsed since the start of the output of the first command Cc. The retarder 28 decreases the braking force Bc based on the first command Cc. When the unmanned vehicle 2 starts in the downhill posture, a decrease in the braking force Bc and the action of gravity allow the unmanned vehicle 2 to start. When the unmanned vehicle 2 starts in the downhill posture, the action of gravity allows the unmanned vehicle 2 to start even when the driving device 26 does not generate driving force.

Note that the command value Vg at the time point tg is a theoretical value calculated based on the above-described equation of motion. For example, even if the output of the first command Cc is started, the unmanned vehicle 2 may fail to start at the time point tg depending on an actual state of the unmanned vehicle 2 or an actual state of the traveling area 10. In the embodiment, the command value of the first command Cc monotonically decreases from the time point tg, so that the unmanned vehicle 2 can start at the first time T3.

The traveling control unit 103 can determine whether or not the unmanned vehicle 2 has started based on the detection data of the speed sensor 32. When the first time T3 elapses, the traveling control unit 103 stops the output of the first command Cc. When the unmanned vehicle 2 does not start even after the first time T3 elapses, the traveling control unit 103 outputs an error signal, and then stops the output of the first command Cc.

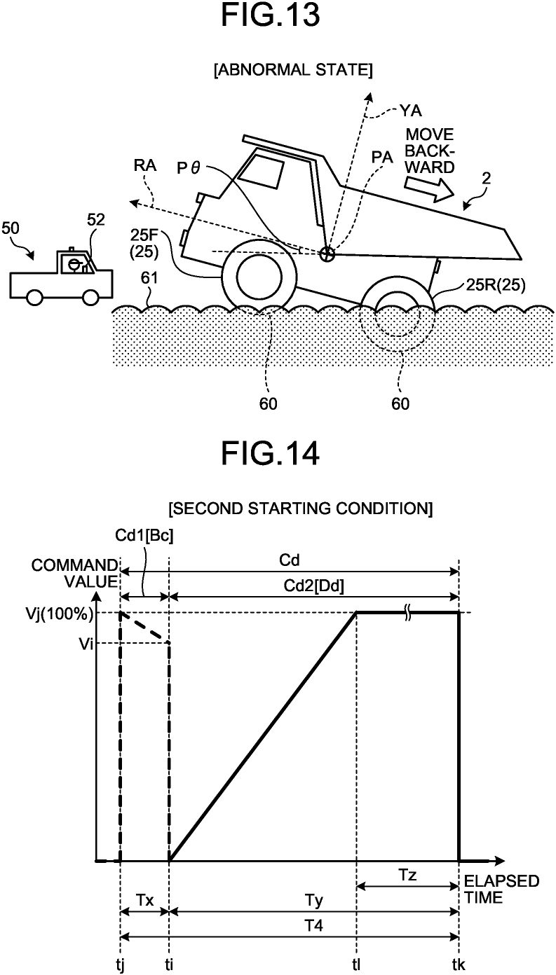

FIG. 13 illustrates one example of the unmanned vehicle 2 in the abnormal state according to the embodiment. FIG. 14 illustrates the second starting condition according to the embodiment. Similarly to the above-described embodiment, the second starting condition is used when the unmanned vehicle 2 is in the abnormal state.

In the embodiment, the second starting condition is used when the unmanned vehicle 2 in the abnormal state starts in a downhill posture. As illustrated in FIG. 13, even when the road surface 61 is substantially parallel to the horizontal plane, for example, when at least a part of the rear tires 25R is buried below the road surface 61, the unmanned vehicle 2 may have the downhill posture. The traveling control unit 103 can determine whether or not the unmanned vehicle 2 starts in the downhill posture based on the course data acquired by the course data acquisition unit 101 and the detection data of the inclination sensor 33 acquired by the sensor data acquisition unit 102.

Note that, in the example of FIG. 13, the unmanned vehicle 2 is inclined such that at least a part of the rear tires 25R is buried below the road surface 61. When the non-contact sensor 34 detects an obstacle at the time when the unmanned vehicle 2 moves forward on the soft road surface 61, the traveling control unit 103 suddenly stops the unmanned vehicle 2 based on the detection data of the non-contact sensor 34. When the unmanned vehicle 2 moving forward suddenly stops, the unmanned vehicle 2 may incline such that the front tires 25F are buried below the road surface 61. Even when the unmanned vehicle 2 inclines such that the front tires 25F are buried below the road surface 61 and then the unmanned vehicle 2 starts, the traveling control unit 103 can determine whether or not the unmanned vehicle 2 starts in the downhill posture based on the course data acquired by the course data acquisition unit 101 and the detection data of the inclination sensor 33 acquired by the sensor data acquisition unit 102.

As illustrated in FIG. 14, when the unmanned vehicle 2 in the abnormal state is started, the traveling control unit 103 outputs a second command Cd. The second command Cd is a control command for starting the unmanned vehicle 2 in the abnormal state. In FIG. 14, the vertical axis represents a command value of the second command Cd, and the horizontal axis represents a time elapsed since a time point tj at which output of the second command Cd is started. The time point tj is start time of the starting control in accordance with the second command Cd. The second command Cd is output only during a second time T4 from the time point tj to a time point tk. The time point tk is end time of the starting control in accordance with the second command Cd. The second time T4 is longer than the first time T3. The second command Cd is output during the second time T4. The first command Cc is output during the first time T3.

In the embodiment, the second command Cd includes an initial command Cd1 and an assist driving command Cd2. The initial command Cd1 is the same as the first command Cc output in an initial time Tx of the first time T3. The assist driving command Cd2 generates assist driving force Dd in the unmanned vehicle 2.

The initial time Tx of the first time T3 refers to a time from the time point tg to a specified time point ti under the first starting condition described with reference to FIG. 12. The specified time point ti may be set between the time point tg and the time point th, or may be the same as the time point th.

In the embodiment, the specified time point ti is set between the time point tg and the time point th. In the embodiment, the initial command Cd1 is the same as a part of the first command Cc. Under the second starting condition, the command value at the time point tj at which output of the initial command Cd1 (braking release command) is started is a command value Vj, which is the same as 100[%]. The command value at the specified time point ti at which output of the initial command Cd1 is ended is a command value Vi, which is smaller than the command value Vj. At the specified time point ti, the command value of the initial command Cd1 decreases from the command value Vi to 0[%].

Output of the initial command Cd1 decreases the braking force Bc generated by the retarder 28.

The assist driving command Cd2 is output after the initial command Cd1 is output. The assist driving command Cd2 is output only during an assist time Ty from the specified time point ti to the time point tk. The second time T4 includes the initial time Tx and the assist time Ty. The initial command Cd1 (braking release command) is output during the initial time Tx. The assist driving command Cd2 is output during the assist time Ty. The assist time Ty is set after the initial time Tx.

The second starting condition is set such that the command value of the assist driving command Cd2 reaches 100[%]. Under the second starting condition, the command value of the assist driving command Cd2 at the specified time point ti is set to 0[%] . A command value of the assist driving command Cd2 at a time point tl between the specified time point ti and the time point tk is set to 100[%]. The command value of the assist driving command Cd2 is set to gradually increase from 0[%] to 100[%] between the specified time point ti and the time point tl. The command value of the assist driving command Cd2 monotonically increases with respect to an elapsed time. A command value of the assist driving command Cd2 is maintained at 100[%] during a maximum output time Tz between the time point tl and the time point tk. Output of the second command Cd (assist driving command Cd2) is stopped at the time point tk at which the second time T4 has elapsed since the start of output of the second command Cd.

In the embodiment, the maximum value of the assist driving force Dd is the maximum value of driving force that can be generated by the driving device 26 of the unmanned vehicle 2.

The maximum output time Tz is longer than the first time T3. The initial time Tx is shorter than the first time T3. The first time T3 is, for example, 15 [sec.]. The maximum output time Tz is, for example, 40 [sec.]. The initial time Tx is, for example, 5 [sec.].

When starting control is performed based on the second starting condition, the traveling control unit 103 starts output of the second command Cd at the time point tj. The traveling control unit 103 outputs the initial command Cd1 (braking release command) such that the braking force Bc generated by the retarder 28 gradually decreases. The traveling control unit 103 outputs the initial command Cd1 (braking release command) such that the retarder 28 does not generate the braking force Bc at the specified time point ti. After the braking force Bc of the retarder 28 is all released and the initial time Tx has elapsed, the traveling control unit 103 outputs the assist driving command Cd2. The traveling control unit 103 monotonically increases the command value of the assist driving command Cd2 with respect to a time elapsed since the start of the output of the assist driving command Cd2. The driving device 26 generates the assist driving force Dd based on the assist driving command Cd2. The traveling control unit 103 sets the command value of the assist driving command Cd2 to 100[%] at the time point tl. The driving device 26 generates the maximum value of the assist driving force Dd. The traveling control unit 103 maintains the command value of the assist driving command Cd2 at 100[%] between the time point tl and the time point tk.

When the unmanned vehicle 2 in the downhill posture is in the abnormal state, the unmanned vehicle 2 may fail to start even if the braking force Bc generated by the retarder 28 is released. That is, in the unmanned vehicle 2 in the abnormal state, at least a part of the tires 25 is buried below the road surface 61, so that resistance received by the tires 25 from the road surface 61 exceeds the gravity acting on the unmanned vehicle 2, which may prevent the unmanned vehicle 2 from starting. In the embodiment, after releasing the braking force Bc of the retarder 28, the traveling control unit 103 outputs the assist driving command Cd2 for causing the unmanned vehicle 2 to generate the assist driving force Dd. The assist time Ty during which the assist driving command Cd2 is output and the maximum output time Tz are longer than the first time T3. Even when at least a part of the tires 25 is buried below the road surface 61 or even when at least a part of the tires 25 enters a groove of the road surface 61, the tires 25 escape from the road surface 61, and the unmanned vehicle 2 can start.

The traveling control unit 103 can determine whether or not the unmanned vehicle 2 has started based on the detection data of the speed sensor 32. When the second time T4 elapses, the traveling control unit 103 stops the output of the second command Cd. When the unmanned vehicle 2 does not start even after the second time T4 elapses, the traveling control unit 103 outputs an error signal, and then stops the output of the second command Cd.

### Selection of First Starting Condition and Second Starting Condition

Also in the embodiment, when the unmanned vehicle 2 is determined not to be started by the first command Cc, the traveling control unit 103 outputs the second command Cd that causes the driving device 26 of the unmanned vehicle 2 to generate the assist driving force Dd.

Similarly to the above-described embodiment, the driver of the auxiliary vehicle 50 determines the state of the unmanned vehicle 2. When the unmanned vehicle 2 is in the abnormal state and the first command Cc is determined not to be able to start the unmanned vehicle 2, the driver operates the operation device 52 to change the output of the first command Cc to the output of the second command Cd. The operation device 52 generates the request command for requesting a change from the output of the first command Cc to the output of the second command Cd. The request command is transmitted to the unmanned vehicle 2. The request command acquisition unit 105 acquires the request command. The traveling control unit 103 outputs the second command Cd based on the request command acquired by the request command acquisition unit 105.

### Effects

As described above, also in the embodiment, when the unmanned vehicle 2 is determined not to be started by the first command Cc, the traveling control unit 103 outputs the second command Cd that causes the unmanned vehicle 2 to generate the assist driving force Dd. The assist driving force Dd is generated after the braking force Bc of the retarder 28 is released, which allows the unmanned vehicle 2 that was not successfully started by the first command Cc to start based on the second command Cd. The unmanned vehicle 2 can start, so that a decrease in productivity of the work site is inhibited.

Furthermore, the initial command Cd1 is the same as a part of the first command Cc. That is, the command value Vj of the second command Cd is the same as the command value Vg, and the decrease rate of the command value of the second command Cd from the time point tj to the specified time point ti is the same as the decrease rate of the command value of the first command Cc. Thus, when the second command Cd is output even though the unmanned vehicle 2 is in the normal state, the sudden start of the unmanned vehicle 2 is inhibited.

### Other Examples

In the embodiment, the second command Cd includes the initial command Cd1 and the assist driving command Cd2. The initial command Cd1 is the same as at least a part of the first command Cc. The assist driving command Cd2 is output after the initial command Cd1. The second command Cd is not required to include the initial command Cd1. The second command Cd is only required to generate the assist driving force Dd. Furthermore, the second command Cd is only required to be output only during the second time T4, which is longer than the first time T3.

In the above-described embodiment, the command value Vg at the time point tg is set to 100[%]. The command value Vg at the time point tg may be set to a value smaller than 100[%].

In the above-described embodiment, the command value of the assist driving command Cd2 is set to monotonically increase from 0[%] to 100[%] between the specified time point ti and the time point tl. The command value of the assist driving command Cd2 may be set to 100[%] at the specified time point ti.

In the above-described embodiment, the maximum output time Tz is longer than the first time T3. The maximum output time Tz may be the same as or shorter than the first time T3.

In the above-described embodiment, the initial time Tx is shorter than the first time T3. The initial time Tx may be the same as or longer than the first time T3.

### Third Embodiment

A third embodiment will be described. In the following description, the same or equivalent components as or to those of the above-described embodiment are denoted by the same reference signs, and the description of the components is simplified or omitted.

### Control System

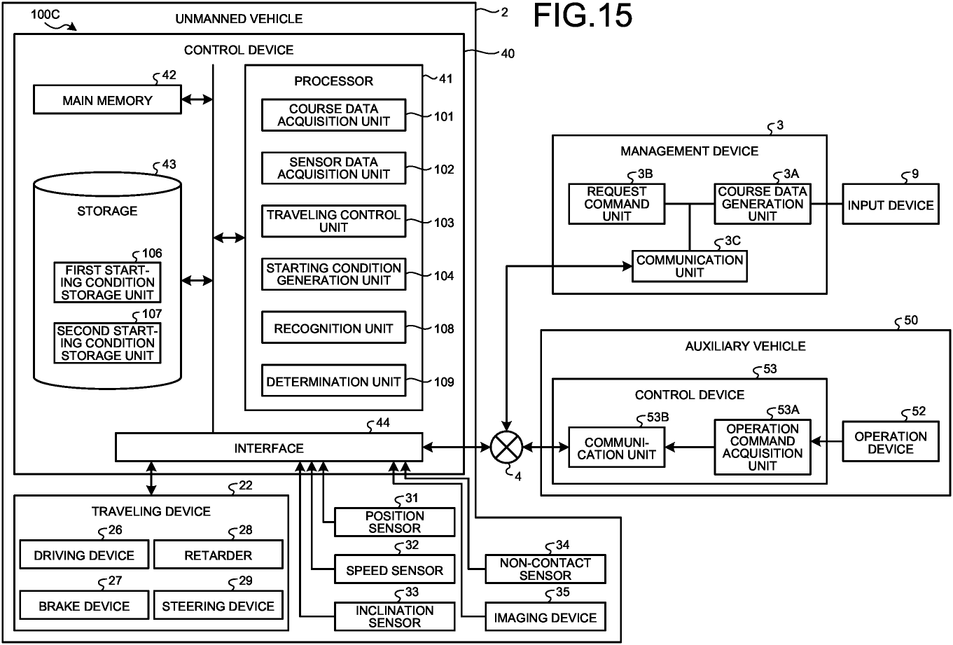

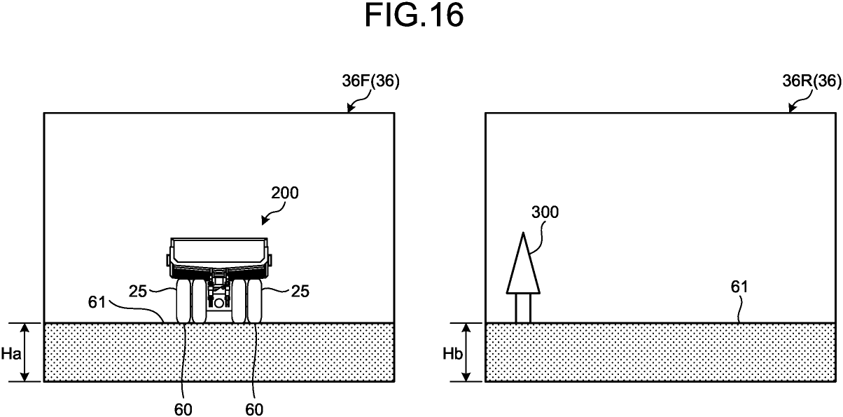

FIG. 15 is a functional block diagram illustrating a control system 100C of the unmanned vehicle according to the embodiment. In the embodiment, the control device 40 includes the course data acquisition unit 101, the sensor data acquisition unit 102, the traveling control unit 103, the starting condition generation unit 104, a recognition unit 108, and a determination unit 109. The processor 41 functions as the recognition unit 108 and the determination unit 109.

The recognition unit 108 recognizes the state of the unmanned vehicle 2. The recognition unit 108 recognizes which of the normal state or the abnormal state the unmanned vehicle 2 is in. In the embodiment, the recognition unit 108 recognizes the state of the unmanned vehicle 2 based on image data on the surroundings of the unmanned vehicle 2. The imaging devices 35 acquire the image data on the surroundings of the unmanned vehicle 2. The sensor data acquisition unit 102 acquires the image data on the surroundings of the unmanned vehicle 2 from the imaging devices 35. The image data on the surroundings of the unmanned vehicle 2 includes data on the terrain of the surroundings of the unmanned vehicle 2. The recognition unit 108 recognizes the state of the unmanned vehicle 2 based on the image data on the surroundings of the unmanned vehicle 2 acquired by the sensor data acquisition unit 102.

The determination unit 109 determines whether or not the unmanned vehicle 2 is started by the first command (Ca, Cc) based on the recognition result of the recognition unit 108. When the recognition unit 108 recognizes that the unmanned vehicle 2 is in the normal state, the determination unit 109 determines that the unmanned vehicle 2 can be started by the first command (Ca, Cc). When the recognition unit 108 recognizes that the unmanned vehicle 2 is in the abnormal state, the determination unit 109 determines that the unmanned vehicle 2 cannot be started by the first command (Ca, Cc).

The traveling control unit 103 outputs the first command (Ca, Cc) or the second command (Cb, Cd) based on the determination result of the determination unit 109. When the determination unit 109 determines that the unmanned vehicle 2 can be started by the first command (Ca, Cc), the traveling control unit 103 outputs the first command (Ca, Cc) in the starting control for the unmanned vehicle 2. When the determination unit 109 determines that the unmanned vehicle 2 cannot be started by the first command (Ca, Cc), the traveling control unit 103 outputs the second command (Cb, Cd) in the starting control for the unmanned vehicle 2.

### Recognition of State of Unmanned Vehicle

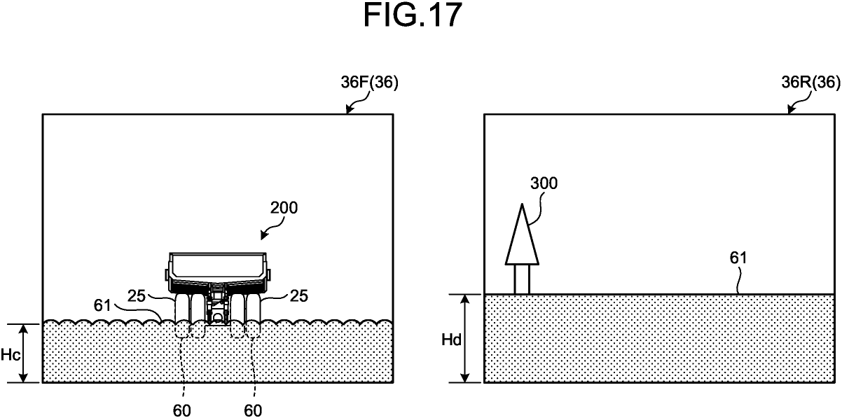

Each of FIGS. 16 and 17 illustrates image data 36 obtained by the imaging devices 35 according to the embodiment. In each of FIGS. 16 and 17, front image data 36F is image data 36 obtained by the front imaging device 35F. Rear image data 36R is image data 36 obtained by the rear imaging device 35R. The front image data 36F includes terrain data indicating the terrain of the traveling area 10 in front of the unmanned vehicle 2. The rear image data 36R includes terrain data indicating the terrain of the traveling area 10 behind the unmanned vehicle 2. Examples of the terrain of the traveling area 10 include the terrain of the road surface 61.

FIG. 16 illustrates the image data 36 acquired at the time when the unmanned vehicle 2 is in the normal state. In the example in FIG. 16, the front image data 36F includes an image of the terrain in front of the unmanned vehicle 2 and an image of another unmanned vehicle 200. The rear image data 36R includes an image of the terrain behind the unmanned vehicle 2 and an image of a structure 300 in the work site. When the road surface 61 is solid, the lower ends 60 of the tires 25 of the other unmanned vehicle 200 are in contact with the road surface 61. When the unmanned vehicle 2 is in the normal state, the roll axis RA of the unmanned vehicle 2 is parallel to the road surface 61. Therefore, in the front image data 36F, the road surface 61 is disposed at a predetermined height Ha. In the rear image data 36R, the road surface 61 is disposed at a predetermined height Hb.

FIG. 17 illustrates the image data 36 acquired at the time when the unmanned vehicle 2 is in the abnormal state. When the road surface 61 is soft, at least a part of the tires 25 of the other unmanned vehicle 200 is buried below the road surface 61. When the unmanned vehicle 2 is in the abnormal state, the roll axis RA of the unmanned vehicle 2 is inclined with respect to the road surface 61. Therefore, in the front image data 36F, the road surface 61 may be disposed at a height Hc different from the height Ha. In the rear image data 36R, the road surface 61 may be disposed at a height Hd different from the height Hb.

As described above, the image data 36 at the time when the unmanned vehicle 2 is in the normal state is different from the image data 36 at the time when the unmanned vehicle 2 is in the abnormal state. The recognition unit 108 can recognize the state of the unmanned vehicle 2 based on the image data 36.

Note that the appearance of the solid road surface 61 is different from the appearance of the soft road surface 61. The recognition unit 108 may perform image processing on the image data 36 to recognize whether or not the road surface 61 is soft, that is, whether or not the unmanned vehicle 2 is in the abnormal state.

Note that the recognition unit 108 may recognize whether or not the unmanned vehicle 2 is in the abnormal state based on a change in the image data 36. For example, when the image data 36 does not change (image data 36 is not moved) even though the traveling control unit 103 has output the first command (Ca, Cc) in the starting control, the recognition unit 108 can recognize that the unmanned vehicle 2 has not started even though the first command (Ca, Cc) has been output. The recognition unit 108 can recognize that the unmanned vehicle 2 is in the abnormal state based on the change in the image data 36.

### Control Method

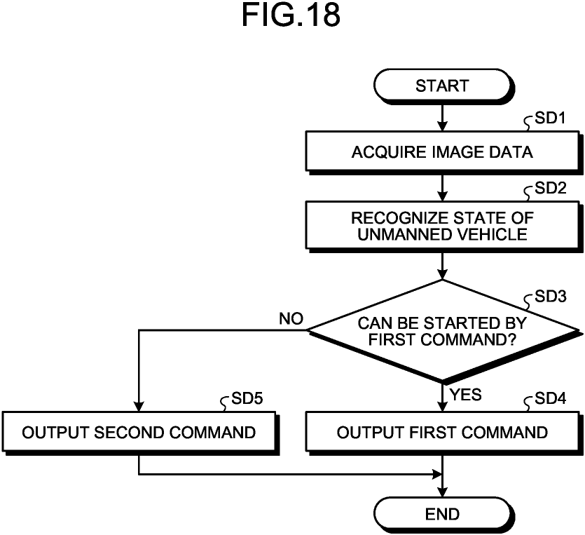

FIG. 18 is a flowchart illustrating a method of controlling the unmanned vehicle 2 according to the embodiment. The imaging devices 35 image the surroundings of the unmanned vehicle 2. The sensor data acquisition unit 102 acquires the image data 36 on the surroundings of the unmanned vehicle 2 from the imaging devices 35 (Step SD1) .

The recognition unit 108 recognizes the state of the unmanned vehicle 2 based on the image data 36 on the surroundings of the unmanned vehicle 2. That is, the recognition unit 108 recognizes which of the normal state or the abnormal state the unmanned vehicle 2 is in based on the image data 36 (Step SD2).

The determination unit 109 determines whether or not the unmanned vehicle 2 can be started by the first command (Ca, Cc) based on the recognition result of the recognition unit 108 in Step SD2 (Step SD3).

When it is determined in Step SD3 that the unmanned vehicle 2 can be started by the first command (Ca, Cc) (Step SD3: Yes), the traveling control unit 103 outputs the first command (Ca, Cc) in the starting control for the unmanned vehicle 2 (Step SD4).

When it is determined in Step SD3 that the unmanned vehicle 2 cannot be started by the first command (Ca, Cc) (Step SD3: No), the traveling control unit 103 outputs the second command (Cb, Cd) in the starting control for the unmanned vehicle 2 (Step SD5).

### Effects

As described above, according to the embodiment, the control device 40 determines whether or not the unmanned vehicle 2 can be started by the first command (Ca, Cc). When the determination unit 109 determines that the unmanned vehicle 2 is not started by the first command (Ca, Cc), the traveling control unit 103 can output the second command (Cb, Cd) that causes the driving device 26 of the unmanned vehicle 2 to generate the assist driving force (Db, Dd).

### Other Examples

In the above-described embodiment, the imaging devices 35 are provided in the unmanned vehicle 2. The imaging devices 35 may be provided outside the unmanned vehicle 2. For example, the imaging devices 35 may be provided at a predetermined position of the work site or in at least one of the loader 7, the auxiliary vehicle 50, an unmanned vehicle different from the unmanned vehicle 2 whose state is recognized, and an unmanned aerial vehicle (UAV). When the imaging devices 35 are provided outside the unmanned vehicle 2, the sensor data acquisition unit 102 can acquire the image data on the surroundings of the unmanned vehicle 2 from the imaging devices 35 via, for example, the management device 3. The recognition unit 108 can recognize the state of the unmanned vehicle 2 based on the image data 36 on the surroundings of the unmanned vehicle 2 acquired by the imaging devices 35 provided outside the unmanned vehicle 2.

In the above-described embodiment, the recognition unit 108 recognizes the state of the unmanned vehicle 2 based on the image data 36 on the surroundings of the unmanned vehicle 2 acquired by the imaging devices 35. The recognition unit 108 may recognize the state of the unmanned vehicle 2 based on three-dimensional data on the surroundings of the unmanned vehicle 2 acquired by an optical sensor. Examples of the optical sensor include a laser sensor (light detection and ranging (LIDAR)) and a radio detection and ranging (RADAR) sensor. The optical sensor detects the terrain around the unmanned vehicle 2, which allows the recognition unit 108 to recognize the state of the unmanned vehicle 2 based on three-dimensional data on the surroundings of the unmanned vehicle 2 acquired by the optical sensor. The optical sensor may be provided in the unmanned vehicle 2, or may be provided outside the unmanned vehicle 2. Note that the recognition unit 108 may recognize the state of the unmanned vehicle 2 based on detection data on the surroundings of the unmanned vehicle 2 acquired by the non-contact sensor 34.

### Other Embodiments

In the above-described embodiments, the unmanned vehicle 2 switches back at the switchback point 19 of the loading place 11, and enters the loading point 20 while moving backward. The unmanned vehicle 2 may enter the loading point 20 while moving forward, and exit from the loading point 20 while moving forward after the loading work ends. That is, the switchback point 19 is not required to be set in the loading place 11.

In the above-described embodiments, an example of the starting control for the unmanned vehicle 2 in the loading place 11 has been described. Also in a case where the unmanned vehicle 2 starts in at least a part of the soil discharging place 12, the parking place 13, the oil filling place 14, and the traveling path 15, the traveling control unit 103 can perform the starting control described in the above-described embodiments.

In the above-described embodiments, the starting condition generation unit 104 generates the starting condition. An arithmetic processing device different from the control device 40 may generate the starting condition. The first starting condition storage unit 106 may store the first starting condition generated by the arithmetic processing device. The second starting condition storage unit 107 may store the second starting condition generated by the arithmetic processing device. The traveling control unit 103 can perform the starting control for the unmanned vehicle 2 in the normal state by using the first starting condition stored in the first starting condition storage unit 106. The traveling control unit 103 can perform the starting control for the unmanned vehicle 2 in the abnormal state by using the second starting condition stored in the second starting condition storage unit 107.

In the above-described embodiments, at least a part of the functions of the control device 40 may be provided in the management device 3, or at least a part of the functions of the management device 3 may be provided in the control device 40. For example, in the above-described embodiment, the management device 3 may have the functions of the starting condition generation unit 104, the first starting condition storage unit 106, and the second starting condition storage unit 107. The first starting condition and the second starting condition may be transmitted from the management device 3 to the control device 40 of the unmanned vehicle 2 via the communication system 4. The traveling control unit 103 can perform the starting control for the unmanned vehicle 2 by using at least one of the first starting condition and the second starting condition transmitted from the management device 3.

Reference Signs List

| | |
|---|---|
| 1 | MANAGEMENT SYSTEM |
| 2 | UNMANNED VEHICLE |
| 3 | MANAGEMENT DEVICE |
| 3A | COURSE DATA GENERATION UNIT |
| 3B | REQUEST COMMAND UNIT |
| 3C | COMMUNICATION UNIT |
| 4 | COMMUNICATION SYSTEM |
| 5 | CONTROL FACILITY |
| 6 | WIRELESS COMMUNICATION DEVICE |
| 7 | LOADER |
| 8 | CRUSHER |
| 9 | INPUT DEVICE |
| 10 | TRAVELING AREA |
| 11 | LOADING PLACE |
| 12 | SOIL DISCHARGING PLACE |
| 13 | PARKING PLACE |
| 14 | OIL FILLING PLACE |
| 15 | TRAVELING PATH |
| 16 | INTERSECTION |
| 17 | TRAVELING COURSE |
| 17A | FIRST TRAVELING COURSE |
| 17B | SECOND TRAVELING COURSE |
| 17C | THIRD TRAVELING COURSE |
| 18 | COURSE POINT |
| 19 | SWITCHBACK POINT |
| 20 | LOADING POINT |
| 21 | VEHICLE BODY |
| 22 | TRAVELING DEVICE |
| 23 | DUMP BODY |
| 24 | WHEEL |
| 24F | FRONT WHEEL |
| 24R | REAR WHEEL |
| 25 | TIRE |
| 25F | FRONT TIRE |
| 25R | REAR TIRE |
| 26 | DRIVING DEVICE |
| 27 | BRAKE DEVICE |
| 28 | RETARDER |
| 29 | STEERING DEVICE |
| 30 | WIRELESS COMMUNICATION DEVICE |
| 31 | POSITION SENSOR |
| 32 | SPEED SENSOR |
| 33 | INCLINATION SENSOR |
| 34 | NON-CONTACT SENSOR |
| 35 | IMAGING DEVICE |
| 35F | FRONT IMAGING DEVICE |
| 35R | REAR IMAGING DEVICE |
| 36 | IMAGE DATA |
| 36F | FRONT IMAGE DATA |
| 36R | REAR IMAGE DATA |
| 40 | CONTROL DEVICE |
| 41 | PROCESSOR |
| 42 | MAIN MEMORY |
| 43 | STORAGE |
| 44 | INTERFACE |
| 50 | AUXILIARY VEHICLE |
| 51 | WIRELESS COMMUNICATION DEVICE |
| 52 | OPERATION DEVICE |
| 53 | CONTROL DEVICE |
| 53A | OPERATION COMMAND ACQUISITION UNIT |
| 53B | COMMUNICATION UNIT |
| 60 | LOWER END |
| 61 | ROAD SURFACE |
| 100 | CONTROL SYSTEM |
| 100C | CONTROL SYSTEM |
| 101 | COURSE DATA ACQUISITION UNIT |
| 102 | SENSOR DATA ACQUISITION UNIT |
| 103 | TRAVELING CONTROL UNIT |
| 104 | STARTING CONDITION GENERATION UNIT |
| 105 | REQUEST COMMAND ACQUISITION UNIT |
| 106 | FIRST STARTING CONDITION STORAGE UNIT |
| 107 | SECOND STARTING CONDITION STORAGE UNIT |
| 108 | RECOGNITION UNIT |
| 109 | DETERMINATION UNIT |
| 200 | UNMANNED VEHICLE |
| 300 | STRUCTURE |
| Bc | BRAKING FORCE |
| Ca | FIRST COMMAND |
| Cb | SECOND COMMAND |
| Cb1 | INITIAL COMMAND |
| Cb2 | ASSIST DRIVING COMMAND |
| Cc | FIRST COMMAND |
| Cd | SECOND COMMAND |
| Cd1 | INITIAL COMMAND |
| Cd2 | ASSIST DRIVING COMMAND |
| Da | NORMAL DRIVING FORCE |
| Db | ASSIST DRIVING FORCE |
| Dd | ASSIST DRIVING FORCE |
| Ha | HEIGHT |
| Hb | HEIGHT |
| Hc | HEIGHT |
| Hd | HEIGHT |
| PA | PITCH AXIS |
| RA | ROLL AXIS |
| YA | YAW AXIS |
| ta | TIME POINT |
| tb | TIME POINT |
| tc | TIME POINT |
| td | TIME POINT |
| te | SPECIFIED TIME POINT |
| tf | TIME POINT |
| tg | TIME POINT |
| th | TIME POINT |
| ti | SPECIFIED TIME POINT |
| tj | TIME POINT |
| tk | TIME POINT |
| tl | TIME POINT |
| T1 | FIRST TIME |
| T2 | SECOND TIME |
| T3 | FIRST TIME |
| T4 | SECOND TIME |
| Tu | INITIAL TIME |
| Tv | ASSIST TIME |
| Tw | MAXIMUM OUTPUT TIME |
| Tx | INITIAL TIME |
| Ty | ASSIST TIME |
| Tz | MAXIMUM OUTPUT TIME |
| Va | COMMAND VALUE |
| Vb | COMMAND VALUE |
| Vc | COMMAND VALUE |
| Ve | COMMAND VALUE |
| Vg | COMMAND VALUE |
| Vh | COMMAND VALUE |
| Vi | COMMAND VALUE |
| Vj | COMMAND VALUE |
| Pθ | PITCH ANGLE |
| Rθ | ROLL ANGLE |
| Yθ | YAW ANGLE |

1. A control system of an unmanned vehicle, comprising
a traveling control unit that outputs a first command for starting the unmanned vehicle,
wherein, when the unmanned vehicle is determined not to be started by the first command, the traveling control unit outputs a second command for causing the unmanned vehicle to generate assist driving force.

2. The control system of an unmanned vehicle according to claim 1,
wherein the first command includes a normal driving command for causing the unmanned vehicle to generate normal driving force, and
the assist driving force is larger than the normal driving force.

3. The control system of an unmanned vehicle according to claim 1,
wherein the first command includes a braking release command for releasing braking force of the unmanned vehicle.

4. The control system of an unmanned vehicle according to claim 1,
wherein the first command is output only during a first time, and
the second command includes: an initial command that is a same as the first command output during an initial time of the first time; and an assist driving command for generating the assist driving force.

5. The control system of an unmanned vehicle according to claim 4,
wherein the second command is output only during a second time, and
the second time is longer than the first time.

6. The control system of an unmanned vehicle according to claim 1,
wherein a maximum value of the assist driving force is a maximum value of driving force that is allowed to be generated by the unmanned vehicle.

7. The control system of an unmanned vehicle according to claim 1, comprising
a request command acquisition unit that acquires a request command for requesting a change from output of the first command to output of the second command,
wherein the traveling control unit outputs the second command based on the request command.

8. The control system of an unmanned vehicle according to claim 7,
wherein the request command is generated by operation of an operation device mounted on a manned vehicle.

9. The control system of an unmanned vehicle according to claim 1, comprising:
a recognition unit that recognizes a state of the unmanned vehicle; and
a determination unit that determines whether or not the unmanned vehicle is started by the first command based on a recognition result of the recognition unit,
wherein the traveling control unit outputs the first command or the second command based on a determination result of the determination unit.

10. The control system of an unmanned vehicle, according to claim 9,
wherein the recognition unit recognizes a state of the unmanned vehicle based on image data on a surrounding of the unmanned vehicle.

11. An unmanned vehicle comprising
the control system of an unmanned vehicle according to claim 1.

12. A method of controlling an unmanned vehicle, comprising:
outputting a first command for starting the unmanned vehicle; and
outputting, when the unmanned vehicle is determined not to be started by the first command, a second command for causing the unmanned vehicle to generate assist driving force.

13. The method of controlling an unmanned vehicle according to claim 12,
wherein the first command includes a normal driving command for causing the unmanned vehicle to generate normal driving force, and
the assist driving force is larger than the normal driving force.

14. The method of controlling an unmanned vehicle according to claim 12,
wherein the first command includes a braking release command for releasing braking force of the unmanned vehicle.

15. The method of controlling an unmanned vehicle according to claim 12,
wherein the first command is output only during a first time, and
the second command includes: an initial command that is a same as the first command output during an initial time of the first time; and an assist driving command for generating the assist driving force.

16. The method of controlling an unmanned vehicle according to claim 15, wherein the second command is output only during a second time, and the second time is longer than the first time.

17. The method of controlling an unmanned vehicle according to claim 12,
wherein a maximum value of the assist driving force is a maximum value of driving force that is allowed to be generated by the unmanned vehicle.

18. The method of controlling an unmanned vehicle according to claim 12, comprising
acquiring a request command for requesting a change from output of the first command to output of the second command,
wherein the second command is output based on the request command.

19. The method of controlling an unmanned vehicle according to claim 18,
wherein the request command is generated by operation of an operation device mounted on a manned vehicle.

20. The method of controlling an unmanned vehicle according to claim 12, comprising:
recognizing a state of the unmanned vehicle; and
determining whether or not the unmanned vehicle is started by the first command based on a recognition result,
wherein the first command or the second command is output based on a determination result.
